(19) United States
(12) Patent Application Publication
(10) Pub. No.: US 2005/0054516 A1
(43) Pub. Date: Mar. 10, 2005

(54) Processes for formulating catalyst compositions having desirable particle size characteristics

(76) Inventors: Stephen Neil Vaughn, Kingwood, TX (US); Yun Feng Chang, Houston, TX (US); S. Douglas Mack, Clemson, SC (US)

Correspondence Address: ExxonMobil Chemical Company;Law Technology, P.O. Box 2149, Baytown, TX, 77522-2149, US

(21) Appl. No.: 10/930,284

(22) Filed: Aug. 31, 2004

Related U.S. Application Data
(60) Provisional application No. 60/500,604, filed on Sep. 5, 2003.

(51) Int. Cl. B01J 29/06

(52) U.S. Cl. 502/64

(57) ABSTRACT

The present invention provides various processes for selectively removing undesirably sized catalyst particles from a catalyst synthesis system. In one embodiment, a slurry is formed containing a molecular sieve, a matrix material, a slurring agent, and optionally a binder. At least a portion of the slurry is dried to produce a first catalyst mixture. At least a portion of catalyst particles are selectively removed from the first catalyst mixture based on their size. The selective removal of particles preferably occurs in a counter-flow cyclone separator. By selectively removing undesirably-sized catalyst particles from the formulated catalyst mixture, desirable fluidization and catalytic activity characteristics can be realized in an OTO reaction system.

### CROSS-REFERENCE TO RELATED APPLICATIONS

This application claims priority to U.S. Provisional Application 60/500,604, filed Sep. 5, 2003.

### FIELD OF THE INVENTION

The present invention relates to processes for forming a mixture of molecular sieve catalyst particles. More particularly, the present invention relates to processes for forming a mixture molecular sieve catalyst particles having a desirable particle size distribution.

### BACKGROUND OF THE INVENTION

Light olefins, defined herein as ethylene and propylene, serve as feeds for the production of numerous chemicals. Olefins traditionally are produced by petroleum cracking. Because of the limited supply and/or the high cost of petroleum sources, the cost of producing olefins from petroleum sources has increased steadily.

The petrochemical industry has known for some time that oxygenates, particularly alcohols, are convertible in the presence of molecular sieve catalysts into light olefins. Molecular sieves are porous solids having pores of different sizes such as zeolites or zeolite-type molecular sieves, carbons and oxides. The most commercially useful molecular sieves for the petroleum and petrochemical industries are known as zeolites, for example, alumnosilicate molecular sieves. Zeolites in general have a one-, two-, or three-dimensional crystalline pore structure having uniformly sized pores of molecular dimensions that selectively adsorb molecules that can enter the pores, and exclude those molecules that are too large.

Typically, molecular sieves are formed into molecular sieve catalyst compositions to improve there durability, control activity and improve cost effectiveness in commercial conversion processes. Molecular sieve catalyst compositions are formed by combining a molecular sieve and matrix material usually in the presence of a binder. Depending upon their size, some molecular sieve catalyst compositions tend to perform better than other molecular sieve catalyst compositions. In conventional processes for formulating molecular sieve catalyst compositions, however, a collection of molecular sieve catalyst compositions are formed having a broad particle size distribution. That is, the collection of molecular sieve catalyst compositions formed by most conventional synthesis processes tend to include at least some undesirably small catalyst particles, e.g., catalyst fines, and/or some undesirably large catalyst particles. As a result, the need exists for an improved processes for formulating molecular sieve catalyst compositions, wherein the improved processes form a population of molecular sieve catalyst composition particles having a desirable median particle diameter and/or particle size distribution.

If too many undesirably small catalyst particles are introduced into a reaction system, then the population of catalyst particles within the reaction system may exhibit an undesirably low median particle diameter and/or an undesirable particle size distribution. Specifically, if the median particle diameter is too low, then the fluidization characteristics within the reaction system may be undesirably affected. For example, if too many small catalyst particles are in the reaction system, these particles may become entrained with the process gas and enter the downstream processing system. These small catalyst particles need to be removed during downstream processing, resulting in a commensurate increase in operating costs. As a result, it is desirable to provide a population of catalyst particles to a reaction system, wherein the population of catalyst particles has a desirable median particle diameter and a desirable particle size distribution.

Additionally, the particle size distribution of catalyst particles within a reaction system tends to vary over time due to small catalyst particle loss and large catalyst particle retention. For example, in an oxygenate to olefin (OTO) reaction system, an oxygenate containing feedstock contacts a molecular sieve catalyst composition under conditions effective to convert at least a portion of the oxygenate to light olefins, which are yielded from the reaction system in a reaction effluent. Due to their relatively high surface area to mass ratios, a portion of catalyst fines in an OTO reaction system may become undesirably entrained with the reaction effluent and exit the reaction system therewith. Conversely, due to their relatively low surface area to mass ratios, larger particles tend to be selectively retained in an OTO reaction system. This varying particle size distribution has a direct impact on fluidization characteristics in a reaction system as well as on product selectivity and conversion.

In view of the importance of providing and maintaining desirably-sized catalyst particles to a reaction system, particularly to an OTO reaction system, improved processes are sought for formulating a population of molecular sieve catalyst composition particles, wherein the population of molecular sieve catalyst composition particles has a desirable median particle diameter and/or particle size distribution.

### SUMMARY OF THE INVENTION

This invention provides novel processes and systems for synthesizing molecular sieve catalyst compositions. In one embodiment, a slurry containing a molecular sieve, a matrix material, a slurring agent, and optionally a binder, is formed. At least a portion of the slurry is dried to produce a first catalyst mixture. At least a portion of catalyst particles is selectively removed from the catalyst mixture based on their size. By selectively removing undesirably-sized catalyst particles from the formulated catalyst mixture, desirable fluidization and catalytic activity characteristics can be realized upon introduction into an OTO reaction system.

Specifically, in one embodiment, the invention is to a process for preparing a mixture of molecular sieve catalyst particles. The process includes the step of forming a slurry containing a molecular sievea slurring agent, optionally a matrix material, and optionally a binder. At least a portion of the slurry is dried to produce a first catalyst mixture. A first portion of catalyst particles is selectively removed from the first catalyst mixture to form a second catalyst mixture. A second portion of catalyst particles is selectively removed from the second catalyst mixture to form a final catalyst mixture, preferably having desirable particle size distribution characteristics. Optionally, the first catalyst mixture has an initial median particle diameter, and the first portion of catalyst particles has a first median particle diameter, which is greater than or less than the initial median particle diameter. Similarly, the second portion of catalyst particles optionally has a second median particle diameter which is greater than or less than the initial median particle diameter. In this embodiment, either the first portion or the second portion of catalyst particles has a median particle diameter greater than the initial median particle diameter, and the other portion of catalyst particles has a median particle diameter less than the initial median particle diameter. Thus, larger catalyst particles from the first catalyst mixture optionally are removed in the first portion or the second portion, and smaller catalyst particles contained in the first catalyst mixture can be removed in the other portion.

In another embodiment, the invention is to a mixture of catalyst particles, comprising a plurality of formulated molecular sieve catalyst particles. Each formulated molecular sieve catalyst particle comprises a molecular sieve, a matrix material, and optionally a binder. The plurality of molecular sieve catalyst particles has a d10 of at least about 5 microns and a d90 of no greater than about 300 microns. Optionally, the d10 is at least about 10 microns, at least about 20 microns, or at least about 45 microns; the d90 is optionally is no greater about 200 microns, no greater than about 150 microns, or no greater than about 120 microns. Optionally, the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

In one embodiment, the invention is to a process for providing molecular sieve catalyst particles. The process includes the step of forming a slurry containing molecular sieve, a matrix material, a slurring agent and optionally a binder. At least a portion of the slurry is dried to produce a first plurality of catalyst particles having a first median particle diameter. A first portion of catalyst particles is selectively removed from the first plurality of catalyst particles to form a second plurality of catalyst particles having a second median particle diameter greater than the first median particle diameter. A second portion of catalyst particles is selectively removed from the second plurality of catalyst particles to form a final plurality of catalyst particles having a final median particle diameter less than the second median particle diameter.

In another embodiment, the invention is to a process for providing molecular sieve catalyst particles, wherein the process includes the step of forming a slurry containing a molecular sieve, a matrix material, a slurring agent, and optionally a binder. At least a portion of this slurry is dried to produce a first plurality of catalyst particles having a first median particle diameter. A first portion of catalyst particles is selectively removed from the first plurality of catalyst particles to form a second plurality of catalyst particles having a second median particle diameter less than the first median particle diameter. A second portion of catalyst particles is selectively removed from the second plurality of catalyst particles to form a final plurality of catalyst particles having a final median particle diameter greater than the second median particle diameter.

In another embodiment, the invention is to a process for producing light olefins. This process comprises the step of providing an oxygenate in an oxygenate containing feedstock. A plurality of molecular sieve catalyst particles is also provided having a d10 of at least about 5 microns and a d90 of no greater than about 300 microns. The oxygenate is contacted with at least one of the molecular sieve catalyst particles under the conditions effective to convert at least a portion of the oxygenate to light olefins. Optionally, the d10 is at least about 10 microns, at least 20 microns, or at least about 45 microns. Optionally, the d90 is no greater than about 200 microns, no greater than about 150 microns, or no greater than about 120 microns.

### BRIEF DESCRIPTION OF THE DRAWINGS

This invention will be better understood by reference to the detailed description of the invention when taken together with the attached drawings, wherein:

FIG. 1 illustrates one embodiment of the present invention;

FIG. 2 illustrates another embodiment of the present invention;

FIG. 3 illustrates another embodiment of the present invention; and

FIG. 4 illustrates a size selective separation device that optionally is implemented according to the present invention.

### DETAILED DESCRIPTION OF THE INVENTION

Introduction

The present invention provides various processes for formulating a plurality of molecular sieve catalyst compositions having a desirable median particle diameter and/or desirable particle size distribution. The present invention is also directed to the resulting mixture of molecular sieve catalyst composition particles having a desirable particle size distribution and/or median particle diameter. In one embodiment of the process of the present invention, a slurry is formed containing a molecular sieve, a matrix material, a slurring agent, and optionally a binder. At least a portion of the slurry is dried to produce a first catalyst mixture. A first portion of catalyst particles is selectively removed from the first catalyst mixture to form a second catalyst mixture. A second portion of catalyst particles is selectively removed from the second catalyst mixture to form a final catalyst mixture, preferably having a desirable particle size distribution and/or median particle diameter.

In a preferred embodiment, the separation unit implemented to selectively remove undesirably-sized catalyst particles from the first and/or second catalyst mixture comprises a tunable cyclone into which a turbulizing stream is introduceable. As used herein, a “turbulizing stream” is a stream which is introduced into a cyclone separator and which at least partially disturbs a downward flow of catalyst particles contained in the cyclone separator. Specifically, the turbulizing stream contacts an outer cyclone (containing larger catalyst particles) formed in the cyclone separator under conditions effective to control the “cut” made by the cyclone separator. Thus, the turbulizing stream contacts at least a portion of the first and/or second catalyst mixture under conditions effective to remove undesirably-sized catalyst particles therefrom.

Processes for Selectively Removing Catalyst Particles From a Formulated Mixture of Catalyst Particles

In a preferred embodiment of the present invention, a slurry is formed, which contains a molecular sieve, a matrix material, a slurring agent, and optionally a binder. At least a portion of the slurry is dried to produce a first catalyst mixture. A first portion of catalyst particles is selectively removed from the first catalyst mixture to form a second catalyst mixture. The first catalyst mixture has an initial median particle diameter, the first portion has a first median particle diameter, and the second portion has a second median particle diameter. Optionally, the first median particle diameter is greater than or less than the initial median particle diameter, and the second median particle diameter is greater than or less than the initial median particle diameter. Preferably, if the first median particle diameter is greater than the initial median particle diameter, then the second median particle diameter is less than the initial median particle diameter. Conversely, if the first median particle diameter is less than the initial median particle diameter, then the second median particle diameter preferably is greater than the initial median particle diameter.

As used herein, the “median particle diameter” is the d50 value for a specified plurality of particles. The dx particle size for purposes of this patent specification and appended claims means that x percent by volume of a specified plurality of particles have a particle diameter no greater than the dx value. For the purposes of this definition, the particle size distribution (PSD) used to define the dx value is measured using well known laser scattering techniques using a Microtrac Model S3000 Particle Size Analyzer from Microtrac, Inc. (Largo, Fla.). “Particle diameter” as used herein means the diameter of a specified spherical particle or the equivalent diameter of nonspherical particles as measured by laser scattering using a Microtrac Model S3000 Particle Size Analyzer.

The precise first and second median particle diameters may vary widely depending upon a variety of factors, such as the type of reaction system to receive the catalyst particles, as well as the reaction conditions in that reaction system. In one preferred embodiment, the first portion of catalyst particles has a first median particle diameter of at least about 120 microns, at least about 140 microns, or at least about 160 microns. The second portion of catalyst particles optionally has a second median particle diameter of no greater than about 45 microns, no greater than about 20 microns, or no greater than about 10 microns. In this embodiment, larger catalyst particles are removed in a first selective removal step, and smaller catalyst particles are removed in a second selective removing step.

The final catalyst mixture preferably has a final median particle diameter, which also will vary greatly depending upon the type of reaction system and the reaction conditions in that reaction system. In one embodiment, the final catalyst mixture has a final median particle diameter of from about 50 to about 100 microns, from about 60 to about 90 microns, or from about 65 to about 85 microns.

In another embodiment, the first selective removal separation step comprises removing smaller catalyst particles, and a second selective removal separation step comprises removing larger catalyst particles. In this embodiment, the first portion of catalyst particles has a first median particle diameter of no greater than about 45 microns, no greater than about 20 microns, or no greater than about 10 microns. In this case, the second portion of catalyst particles optionally has a second median particle diameter of at least about 120 microns, at least about 140 microns, or at least about 160 microns.

As disclosed in more detail below, the desirably-sized mixture of catalyst particles formulated according to the present invention preferably is implemented in an oxygenate to olefin (OTO) reaction system. As used herein, “reaction system” means a system comprising a reactor unit (defining a reaction zone), a disengaging unit (defining a disengaging zone), optionally a catalyst regenerator, optionally a catalyst cooler, optionally a catalyst stripper, and optionally conduit lines connecting these units. An OTO reaction system preferably comprises one or more reactor units, catalyst strippers, regeneration units, catalyst coolers, and conduit lines connecting these units. Optionally, the desirably-sized mixture of catalyst particles is introduced into the OTO reaction system at one or more of the reactor units, catalyst strippers, regeneration units, catalyst coolers, and/or the conduit lines connecting these units. The reactor unit defines a reaction zone, in which the conversion of oxygenates to olefins occurs, and a disengaging zone, which is provided to separate catalyst particles from products of the reaction process. Optionally, the desirably-sized mixture of catalyst particles that is formulated according to the present invention is introduced into the OTO reaction system at one or more of the reaction zones, and/or the disengaging zone.

The first catalyst mixture optionally comprises catalyst fines, catalyst nonfines, catalyst coarses, and/or catalyst noncoarses. For purposes of this patent specification, “catalyst fines” are defined herein as a collection of formulated catalyst composition particles having a median particle diameter no greater than 20 microns. As used herein, “catalyst nonfines” are defined herein as a collection of formulated catalyst composition particles having a median particle diameter greater than 20 microns. “Catalyst coarses” are defined herein as a collection of formulated catalyst composition particles having a median particle diameter of at least 120 microns. As used herein, “catalyst noncoarses” are defined herein as a collection of formulated catalyst composition particles having a median particle diameter of less than 120 microns. A “heart cut” is defined herein as a collection of formulated catalyst composition particles having a median particle diameter greater than 20 microns and less than 120 microns. As used herein, the terms “large” and “small,” when referring to a population of catalyst particles, are relative and refer to a median particle diameter of a plurality of catalyst particles. Thus, a “large” catalyst stream may contain some small catalyst particles, e.g., catalyst fines. Additionally, the size of particles contained in a “large catalyst stream” and a “small catalyst stream” will vary depending on the particle size distribution of a parent stream that is separated to produce the large and small catalyst streams. Thus, a large catalyst stream might not contain any catalyst coarses, if the parent stream from which it was derived did not contain catalyst coarses. Similarly, a small catalyst stream might not contain any catalyst fines, if the parent stream from which it was derived did not contain catalyst fines.

In each of the processes for formulating catalyst particles according to the present invention, the disposition of the undesirably-sized catalyst particles (e.g., the first portion and/or the second portion of catalyst particles) may vary widely. In one particularly preferred embodiment, the undesirably-sized catalyst particles (either large or small sized) are recycled into a slurry for the production of additional catalyst particles. In this manner, the molecular sieves and other components in the catalyst formulation, which can be quite expensive for OTO reaction systems, that were present in the undesirably-sized catalyst particles can be recycled into a new batch of catalyst particles. Alternatively, a portion of the undesirably-sized catalyst particles are disposed of.

In one embodiment, the undesirably-sized catalyst particles are categorized and stored for later use. In this embodiment, for example, should a reaction system exhibit undesirably low fluidization characteristics, small catalyst particles (e.g., catalyst fines) and/or larger catalyst particles (e.g., catalyst coarses) optionally are introduced into the reaction system as necessary in order to provide desirable fluidization and catalytic activity characteristics within the reaction system. Moreover, should a batch of formulated molecular sieve catalyst composition particles exhibit an undesirable particle size distribution and/or median particle diameter, that batch of molecular sieve catalyst composition particles may be combined with previously separated small and/or large molecular sieve catalyst composition particles in order to obtain a final mixture of molecular sieve catalyst particles having a desirable particle size distribution and/or median particle diameter.

Typically, the median particle diameter and particle size distribution of a population of catalyst particles within a reaction system will vary over time. This is due in part to loss of smaller catalyst particles, e.g., catalyst fines, from the reaction system. The loss of the smaller catalyst from the reaction system results in a gradual increase in particle size distribution and median particle diameter over time. In a preferred OTO reaction system, the oxygenate containing feedstock flows up a riser reactor with a population of catalyst particles at a relatively high weight hourly space velocity and superficial gas velocity. As the oxygenate containing feedstock travels up the riser reactor, it is converted to light olefins. The resulting light olefins and catalyst particles are transferred from the top of the riser actor to a disengaging zone for separation of catalyst particles from the light olefin product. Specifically, in the disengaging zone, a majority of the catalyst particles fall to the bottom thereof while the light olefins and any other gaseous components yielded from the riser reactor are directed under pneumatic pressure to one or more separation units, preferably one or more cyclone separators. Upon introduction to the cyclone separators, entrained catalyst particles are further separated from the gaseous components yielded from the riser reactor. However, commercially available separation units do not provide 100% efficiency for removal of catalyst particles, and at least a portion of the catalyst particles, particularly catalyst fines, remain entrained with the light olefins and other gaseous components which are yielded from the disengaging zone in a reaction effluent stream. In order to compensate for this gradual loss of lighter catalyst particles, particularly catalyst fines, lighter catalyst particles previously separated from a formulated catalyst mixture optionally are periodically or continuously introduced into the reaction system. Similarly, larger catalyst particles, which tend to lose their reactivity over time, within the reaction system may be selectively removed from the reaction system, as described in U.S. patent application Ser. No. 10/656,673, filed on Sep. 5, 2003, the entirety of which is incorporated herein by reference. In order to counteract this selective removal of larger catalyst particles, a large relatively fresh catalyst stream previously separated from a formulated catalyst mixture may be introduced into the reaction system.

Thus, in one embodiment, the process of the present invention provides for the ability to maintain a desired particle size distribution within a reaction system although a portion of the catalyst fines in the reaction system may exit the reaction system with the product effluent. In this embodiment, the present invention provides a process for selectively separating smaller catalyst particles from a formulation mixture. The smaller catalyst particles optionally have median particle diameter of no greater than about 45 microns, no greater than about 20 microns or no greater than about 10 microns. As the median particle diameter of the population of catalyst particles within the reaction system increases due to the loss of smaller catalyst particles from the reaction system, the separated smaller catalyst particles from the formulated catalyst mixture can be introduced into the reaction system thereby providing for a decrease in median particle diameter of the entire population of catalyst particles within the reaction system.

Similarly, in another embodiment, the process of the present invention provides for the ability to maintain a desired particle size distribution within a reaction system although a portion of the catalyst coarses in the reaction system may have been selectively removed. In this embodiment, the present invention provides a process for selectively separating larger catalyst particles from a formulation mixture. The larger catalyst particles optionally have median particle diameter of at least about 120 microns, at least about 140 microns or at least about 160 microns. As the median particle diameter of the population of catalyst particles within the reaction system decreases due to the loss of larger catalyst particles from the reaction system, the separated larger catalyst particles from the formulated catalyst mixture can be introduced into the reaction system thereby providing for an increase in median particle diameter of the entire population of catalyst particles within the reaction system.

These embodiments optionally further comprise a step of monitoring the median particle diameter of the population of catalyst particles within a reaction system. The monitoring preferably is performed by a laser scattering particle size analyzer such as a Microtrac Model S3000 Particle Size Analyzer from Microtrac, Inc. (Largo, Fla.). The monitoring may occur either online or offline. In this embodiment, the step of directing a portion of the fresh catalyst particles (either larger or smaller catalyst particles) to the reaction system is responsive to a determination in the monitoring step that the median particle diameter of the population of catalyst particles within the reaction system has exceeded or fallen below a predetermined limit. The predetermined limit may vary widely, but in the embodiment wherein smaller catalyst particles are replaced, the predetermined limit optionally is greater than 120 microns, between about 100 and about 120 microns, or between about 90 and about 100 microns. In the embodiment wherein larger catalyst particles are selectively removed and replaced by fresh larger catalyst particles from the formulated catalyst mixture, the predetermined limit optionally is less than about 90 microns, between about 75 microns and about 90 microns, or between about 65 microns and about 75 microns. The monitoring optionally is performed by a laser scattering particle size analyzer, as described above, or by a Coulter Counter, by a device for determining rate of sedimentation, or by a mechanical screening device.

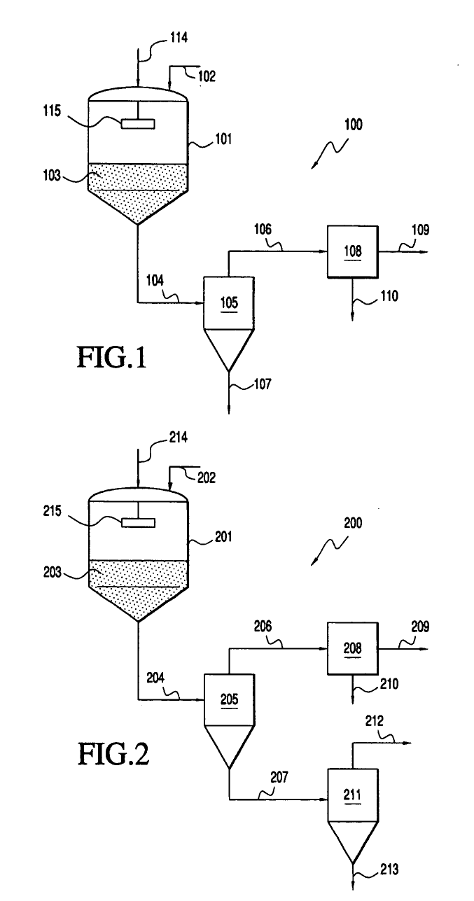

FIGS. 1-3 illustrate three non-limiting exemplary embodiments of the present invention. FIG. 1, for example, illustrates a separation system of the present invention, generally designated 100, wherein undesirably-sized catalyst particles (either or both undesirably large and/or undesirably small) are selectively separated from the formulated catalyst mixture. As shown, a catalyst slurry 114 is directed to a forming unit 101, wherein the catalyst slurry 114 is dried to form a population of catalyst particles 103. As shown, forming unit 101 receives a drying medium 102 to facilitate the drying of catalyst slurry 114. The catalyst slurry 114 is directed to an atomizer 115, which distributes the catalyst slurry 114 into small droplets. The atomizer optionally comprises a spinning wheel or single or dual-fluid nozzles. The sizes of the droplets are controlled by many factors including slurry viscosity, surface tension, flow rate, pressure, temperature of the catalyst slurry 114, the shape and dimensions of the nozzles, pressure drop across the nozzle, relative flow rate of an atomizing fluid stream, or the spinning rate of an atomizing wheel. The droplets optionally are dried by a co-current or countercurrent flow of air (or other dying medium) passing through a spray drier to form dry catalyst particles 103.

Dry catalyst particles 103 may contain a relatively broad particle size distribution. The particle size distribution and median particle diameter of dry catalyst particles 103 can be desirably controlled according to the present invention. As shown, first catalyst mixture 104, which comprises a portion of the dry catalyst particles 103, is directed from forming unit 101 to first separation unit 105. First separation unit 105 preferably separates the first catalyst mixture 104, which has an initial median particle diameter, into a first small catalyst stream 106, which comprises a gaseous carrying medium, e.g., air, in addition to smaller catalyst particles, and a first large catalyst stream 107, which comprises larger catalyst particles. First small catalyst stream 106 has a first median particle diameter, and first large catalyst stream 107 has a second median particle diameter. Ideally, the first median particle diameter is less than the initial median particle diameter, and the second median particle diameter is greater than the initial median particle diameter.

First separation unit 105 preferably is selected from the group consisting of a cyclone separator, a settling vessel, and an air classifier. In a preferred embodiment, first separation unit 105 comprises a counter flow cyclone separator, which optionally is tunable to adjust the cut between first small catalyst stream 106 and first large catalyst stream 107.

As shown, first small catalyst stream 106 is directed to a fines collection unit 108. Fines collection unit 108 optionally comprises a filtering medium to separate entrained catalyst particles from the gaseous components contained in first small catalyst stream 106. In this manner, fines collection unit 108 separates catalyst fines 110 from carrying medium 109. Optionally, the fines collection unit 108 comprises a bag house, a wet gas scrubber, or an electrostatic precipitator.

FIG. 2 illustrates another separation system of the present invention, generally designated 200, wherein small and large catalyst particles are selectively removed from a first catalyst mixture to form a population of desirably-sized catalyst particles. As shown, a catalyst slurry 214 is directed to a forming unit 201, wherein the catalyst slurry 214 is dried to form a population of catalyst particles 203. As shown, forming unit 201 receives a drying medium 202 to facilitate the drying of catalyst slurry 214. The catalyst slurry 214 is directed to an atomizer 215, which distributes the catalyst slurry 214 into small droplets. The atomizer optionally comprises a spinning wheel or single or dual-fluid nozzles. The sizes of the droplets are controlled by many factors including slurry viscosity, surface tension, flow rate, pressure, temperature of the catalyst slurry 214, the shape and dimensions of the nozzles, pressure drop across the nozzle, relative flow rate of an atomizing fluid stream, or the spinning rate of an atomizing wheel. The droplets optionally are dried by a co-current or countercurrent flow of air (or other dying medium) passing through a spray drier to form dry catalyst particles 203.

Dry catalyst particles 203 may contain a relatively broad particle size distribution. The particle size distribution and median particle diameter of dry catalyst particles 203 can be desirably controlled according to the present invention. As shown, first catalyst mixture 204, which comprises a portion of the dry catalyst particles 203, is directed from forming unit 201 to first separation unit 205. First separation unit 205 preferably separates the first catalyst mixture 204, which has an initial median particle diameter, into a first small catalyst stream 206, which comprises a gaseous carrying medium, e.g., air, in addition to smaller catalyst particles, and a first large catalyst stream 207, which comprises larger catalyst particles. First small catalyst stream 206 has a first median particle diameter, and first large catalyst stream 207 has a second median particle diameter. Ideally, the first median particle diameter is less than the initial median particle diameter, and the second median particle diameter is greater than the initial median particle diameter.

As shown, first small catalyst stream 206 is directed to a fines collection unit 208. Fines collection unit 208 optionally comprises a filtering medium to separate entrained catalyst particles from the gaseous components contained in first small catalyst stream 206. In this manner, fines collection unit 208 separates catalyst fines 210 from carrying medium 209. Optionally, the fines collection unit 208 comprises a bag house, a wet gas scrubber, or an electrostatic precipitator.

In this embodiment, first large catalyst stream 207 is directed from first separation unit 205 to second separation unit 211. Second separation unit 211 preferably separates the first large catalyst stream 207 into a second small catalyst stream 212, which comprises a gaseous carrying medium, e.g., air, in addition to catalyst particles, and a second large catalyst stream 213, which comprises larger catalyst particles. Second small catalyst stream 212 has a third median particle diameter, and second large catalyst stream 213 has a fourth median particle diameter. Ideally, the third median particle diameter is less than the second median particle diameter, and the fourth median particle diameter is greater than the second median particle diameter. The third median particle diameter preferably is between about 50 and 100 microns, from about 60 to about 90 microns, or from about 65 to about 85 microns. Thus, in this embodiment, second small catalyst stream 212 comprises catalyst particles having a desirably particle size distribution and/or median particle diameter. Second small catalyst stream 212 preferably is directed to an OTO reaction system to catalyze the conversion of oxygenates to light olefins. Either or both the catalyst fines 210 and/or the second large catalyst stream 213 are recycled to a catalyst synthesis process to form additional catalyst compositions.

Either or both first separation unit 205 and/or second separation unit 211 optionally is selected from the group consisting of a cyclone separator, a settling vessel, and an air classifier. In a preferred embodiment, both first separation unit 205 and second separation unit 211 comprise counter flow cyclone separators, which optionally are tunable to adjust the cuts, respectively, between first small catalyst stream 206 and first large catalyst stream 207, and between second small catalyst stream 212 and second large catalyst stream 213.

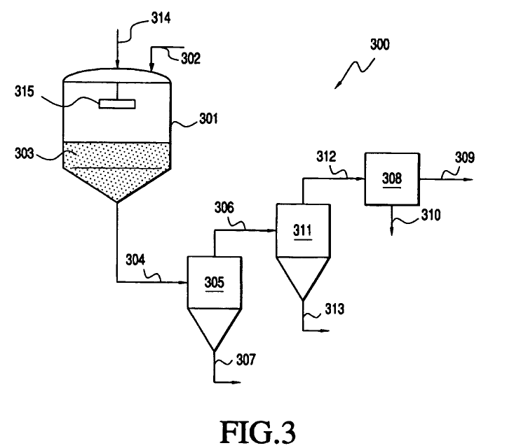

FIG. 3 illustrates another separation system of the present invention, generally designated 300, wherein small and large catalyst particles are selectively removed from a first catalyst mixture to form a population of desirably-sized catalyst particles. As shown, a catalyst slurry 314 is directed to a forming unit 301, wherein the catalyst slurry 314 is dried to form a population of catalyst particles 303. As shown, forming unit 301 receives a drying medium 302 to facilitate the drying of catalyst slurry 314. The catalyst slurry 314 is directed to an atomizer 315, which distributes the catalyst slurry 314 into small droplets. The atomizer optionally comprises a spinning wheel or single or dual-fluid nozzles. The sizes of the droplets are controlled by many factors including slurry viscosity, surface tension, flow rate, pressure, temperature of the catalyst slurry 314, the shape and dimensions of the nozzles, pressure drop across the nozzle, relative flow rate of an atomizing fluid stream, or the spinning rate of an atomizing wheel. The droplets optionally are dried by a co-current or countercurrent flow of air (or other dying medium) passing through a spray drier to form dry catalyst particles 303.

Dry catalyst particles 303 may contain a relatively broad particle size distribution. The particle size distribution and median particle diameter of dry catalyst particles 303 can be desirably controlled according to the present invention. As shown, first catalyst mixture 304, which comprises a portion of the dry catalyst particles 303, is directed from forming unit 301 to first separation unit 305. First separation unit 305 preferably separates the first catalyst mixture 304, which has an initial median particle diameter, into a first small catalyst stream 306, which comprises a gaseous carrying medium, e.g., air, in addition to smaller catalyst particles, and a first large catalyst stream 307, which comprises larger catalyst particles. First small catalyst stream 306 has a first median particle diameter, and first large catalyst stream 307 has a second median particle diameter. Ideally, the first median particle diameter is less than the initial median particle diameter, and the second median particle diameter is greater than the initial median particle diameter.

In this embodiment, first small catalyst stream 306 is directed from first separation unit 305 to second separation unit 311. Second separation unit 311 preferably separates the first small catalyst stream 306 into a second small catalyst stream 312, which comprises a gaseous carrying medium, e.g., air, in addition to smaller catalyst particles, and a second large catalyst stream 313, which comprises desirably-sized larger catalyst particles. Second small catalyst stream 312 has a third median particle diameter, and second large catalyst stream 313 has a fourth median particle diameter. Ideally, the third median particle diameter is less than the first median particle diameter, and the fourth median particle diameter is greater than the first median particle diameter.

As shown, second small catalyst stream 312 is directed to a fines collection unit 308. Fines collection unit 308 optionally comprises a filtering medium to separate entrained catalyst particles from the gaseous components contained in second small catalyst stream 313. In this manner, fines collection unit 308 separates catalyst fines 310 from carrying medium 309. Optionally, the fines collection unit 308 comprises a bag house, a wet gas scrubber, or an electrostatic precipitator.

The fourth median particle diameter preferably is between about 50 and 100 microns, from about 60 to about 90 microns, or from about 65 to about 85 microns. Thus, in this embodiment, second large catalyst stream 313 comprises catalyst particles having a desirably particle size distribution and/or median particle diameter. Second large catalyst stream 313 preferably is directed to an OTO reaction system to catalyze the conversion of oxygenates to light olefins. Either or both the catalyst fines 310 and/or the first large catalyst stream 307 are recycled to a catalyst synthesis process to form additional catalyst compositions.

Either or both first separation unit 305 and/or second separation unit 311 optionally is selected from the group consisting of a cyclone separator, a settling vessel, and an air classifier. In a preferred embodiment, both first separation unit 305 and second separation unit 311 comprise counter flow cyclone separators, which optionally are tunable to adjust the cuts, respectively, between first small catalyst stream 306 and first large catalyst stream 307, and between second small catalyst stream 312 and second large catalyst stream 313.

Exemplary Separation Devices

Any of a number of separation units may be implemented according to the present invention to separate a plurality of catalyst particles into a small catalyst stream and a large catalyst stream. A non-limiting exemplary list of separation units that may be used according to the present invention include: cyclone separators, settling vessels, screens, and air classifiers.

The design and operation of cyclone separators are known to those skilled in the art. See, for example, U.S. Pat. Nos. 5,518,695; 5,290,431; 4,904,281; 4,670,410; 2,934,494 and 2,535,140, the entireties of which are all incorporated herein by reference. In the operation of a cyclone separator, vapor components and optionally a minor amount of entrained particulates are urged by pneumatic pressure up the cyclone separator and through a top outlet, while heavier particles, by virtue of their inertia and centrifugal force, tend to move toward the outside separator wall, from which they are urged by gravity in a downward direction into a receiver and ultimately through a large particle stream outlet. The centrifugal separating force for acceleration may range from 5 times gravity in very large diameter, low resistance cyclones, to 2500 times gravity in very small high resistance units.

Specifically, gaseous material and a collection of particulate material enter the cyclone separator through a tangentially oriented inlet. The collection of particulate material preferably comprises catalyst particles of varying sizes; some particles being larger and/or smaller than others. Tangential entry of the gaseous and particulate material creates a swirling action of the gaseous and particulate material inside the cyclone separator and establishes an inner vortex pattern and an outer vortex pattern.

Centrifugal acceleration of the particulate material in the cyclone separator tends to urge larger particulate material outwardly to the wall of the of the cyclone separator. As a result, the outer vortex pattern tends to comprise a greater amount of the larger particulate material than the inner vortex, which comprises gaseous components and smaller particulate material, e.g., catalyst fines. In addition to centrifugal forces, gravity tends to urge the larger particulate material in the outer vortex downward. In one embodiment, the larger particulate material falls along the wall of the cyclone separator and collects in a hopper of the cyclone separator. The collected particulate material optionally is then directed to a recycling facility, wherein the collected particulate material is formulated into a catalyst composition having desirable particle size characteristics.

At some point the cyclone separator, the outer vortex terminates and the inner vortex is formed, which comprises gaseous components and smaller particulate material. The inner vortex progresses upwardly through the cyclone separator under pneumatic pressure and enters an outlet tube, also referred to herein as an inner hollow cylindrical member, which preferably is attached to a laterally extending top surface, which defines the top of the cyclone separator. The outlet tube optionally has a diameter that approximates the outer periphery of the inner cyclone vortex. Optionally, the outlet tube traverses the laterally-extending top surface of the cyclone separator and extends downwardly into the inner volume of the cyclone separator in order to facilitate size-selective separation.

Structurally, the cyclone separator preferably includes an outer hollow cylindrical member having a laterally extending top surface at its distal end and an open end at its proximal end. As used herein, a proximal end of a specified component is that end of the component that is nearest to grade. Conversely, the distal end of a specified component is that end of the component that is furthest removed from grade. The open end of the outer hollow cylindrical member preferably is in open communication with a hollow conical member having a broad distal end that narrows into a narrow proximal end. The narrow proximal end of the hollow conical member preferably forms an opening at its apex. The apex opening optionally is in open communication with a standpipe which is adapted to transport large particulate material.

The outlet tube preferably traverses the laterally extending top surface of the cyclone separator and extends into the inner volume formed by the outer hollow cylindrical member. At its proximal end, the inner hollow cylindrical member includes a small stream outlet, which preferably is adapted to receive small components from the inner vortex created within the cyclone separator. The outer hollow cylindrical member also includes an inlet, which is adapted to receive a particulate laden stream from the reaction system. Ideally, the inlet to the outer hollow cylindrical member introduces the particle laden stream in a tangential manner with respect to the outer hollow cylindrical member such that as the particulate laden stream is introduced into the outer hollow cylindrical member it forms an outer vortex within the outer hollow cylindrical member.

In operation, as catalyst particles are introduced into the cyclone separator, the larger catalyst particles are urged along the inner surface of the outer hollow cylindrical member, while the smaller catalyst particles, due to their lower mass, tend to become entrained with the gaseous components and form the inner vortex within the cyclone separator. Gravity and centrifugal forces tend to direct the larger and heavier catalyst particles from the outer hollow cylindrical member through its open end and into the hollow conical member. The hollow conical member tends to direct the larger catalyst particles from the outer hollow cylindrical member to the apex opening and optionally to a standpipe. Smaller components that were introduced into the separator inlet tend to be forced into small stream outlet and into the inner hollow cylindrical member by pneumatic forces. In this manner, smaller particles and gaseous components that enter the cyclone separator tend to separated from heavier particulate materials.

In a particularly preferred embodiment of the present invention, the separation unit comprises a counter flow cyclone separator. A counter flow cyclone separator operates in a manner similar to a normal cyclone separator. However, in a counter flow cyclone separator, the heavier catalyst particles that flow along the outer wall of the cyclone separator, e.g., the outer vortex, contact a turbulizing stream, which creates a turbulent environment within the counter flow cyclone separator. The formation of a turbulent environment within the counter flow cyclone separator tends to urge smaller particulate materials, that may have become entrained with the larger catalyst particles in the outer vortex, into the inner vortex and ultimately out of the counter flow cyclone separator with the gaseous and smaller particulate components present in the inner vortex. That is, the turbulizing stream causes a portion of the particles in the outer vortex (typically, smaller particles) to be transferred to the inner vortex.

Specifically, in the counter flow cyclone separator, a particulate laden stream enters an outer hollow cylindrical member or hollow conical member tangentially at one or more separator inlets. As with conventional cyclones, tangential entry of the gaseous and particulate material creates a swirling action of the gaseous and particulate material inside the counter flow cyclone separator and establishes an inner vortex pattern and an outer vortex pattern. Centrifugal acceleration of the particulate material in the cyclone separator tends to urge larger particulate material outwardly to the wall of the of the cyclone separator. As a result, the outer vortex pattern tends to comprise a greater amount of the larger particulate material than the inner vortex, which comprises gaseous components and smaller particulate material, e.g., catalyst fines. In addition to centrifugal forces, gravity tends to urge the larger particulate materials in the outer vortex downward. The outer vortex, however, may contain a minor amount of entrained smaller or medium sized particles, a portion of which optionally is transferred to the inner vortex, described below, by the turbulizing stream.

At some point within the counter flow cyclone separator, the outer vortex terminates and an inner vortex is formed, which comprises gaseous components and smaller particulate material. The inner vortex progresses upwardly through the cyclone separator under pneumatic pressure and enters an inner hollow cylindrical tube, also referred to herein as an “outlet tube”, which preferably is attached to a laterally extending top surface that defines the top of the cyclone separator. The outlet tube optionally has a diameter that approximates the outer periphery of the inner cyclone vortex. Optionally, the outlet tube traverses the laterally-extending top surface of the counter flow cyclone separator and extends downwardly into the inner volume of the cyclone separator in order to facilitate size-selective separation.

Structurally, the counter flow cyclone separator preferably includes an outer hollow cylindrical member having a laterally extending top surface at its distal end and an open end at its proximal end. The open end of the outer hollow cylindrical member preferably is in open communication with a hollow conical member having a broad distal end that narrows into a narrow proximal end. The narrow proximal end of the hollow conical member preferably forms an opening at its apex. The apex opening optionally is in open communication with a standpipe which is adapted to transport large particulate material away from the counter flow cyclone separator.

Additionally, the counter flow cyclone separator comprises a second inlet for receiving a turbulizing stream. The second inlet optionally is situated on the outer hollow cylindrical member or the hollow conical member. The second inlet optionally introduces the turbulizing stream into one or more of the outer hollow cylindrical member or the hollow conical member. Inside the counter flow cyclone separator, at least a portion of the plurality of catalysts particles in the outer vortex contacts the turbulizing stream under conditions effective to the separate some smaller catalyst particles from the outer vortex. At least a portion of these separated smaller catalyst particles become entrained with the inner vortex and exit the cyclone separator through the outlet tube with the gaseous and smaller catalyst particles.

The second inlet receives the turbulizing stream from a turbulizing stream utility source (e.g., air, nitrogen or steam) or storage unit, e.g., a pressurized tank or other storage vessel, or from a conduit in fluid communication with a plant utility line, such as an air or nitrogen-containing stream. A turbulizing stream conduit line transports the turbulizing stream from the storage unit or plant utility line to the second inlet. Preferably the turbulizing stream conduit includes one or more flow control valves adapted to adjustably control the flow of turbulizing stream that is introduced into the counter flow cyclone separator, depending upon the desired separation characteristics.

In operation, as the turbulizing stream is introduced via second inlet into the counter flow cyclone separator, the turbulizing stream tends to disturb the cyclone formed by the catalyst particles in the counter flow cyclone separator in a turbulent manner. By disturbing the flow of catalyst particles in the counter flow cyclone separator, smaller catalyst particles tend to be transferred from the outer vortex to the inner vortex and ultimately enter the small stream outlet in the inner hollow cylindrical member. Notwithstanding the introduction of the turbulizing stream into the counter flow cyclone separator, larger catalyst particles will tend to continue to be transported through the standpipe and ultimately out of the large stream outlet.

Thus, unlike conventional cyclone separators, a counter flow cyclone separator tends to facilitate the removal of smaller catalyst particles that have become entrained with the larger catalyst particles in the outer vortex. Advantageously, if the counter flow cyclone separator includes one or more flow control valves about the turbulizing streamconduit line, then the particle size distribution of the small catalyst stream, which exits the counter flow cyclone separator via small stream outlet, is fully controllable by the actuation of the one or more flow control valves. In another preferred embodiment, the counter flow cyclone separator includes a plurality of hollow conical members and a plurality of cylindrical members, preferably arranged in an alternating manner. Optionally, a plurality of counter flow cyclone separators may be in open communication with one another to facilitate the separation of undesirably-sized catalyst particles from desirably-sized catalyst particles.

The turbulizing stream that is implemented according to the present invention may vary widely. An exemplary non-limiting list of turbulizing mediums includes: air, nitrogen and steam. Optionally, the inner hollow cylindrical member is in open communication with a scroll outlet which deviates the flow of the small catalyst stream by about 90°.

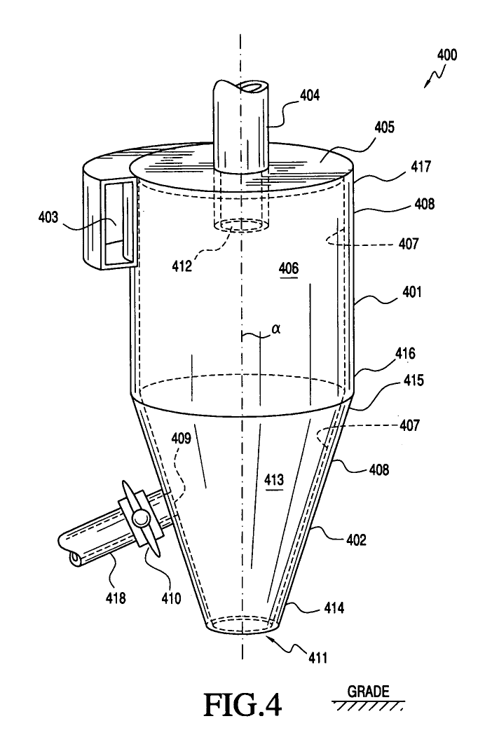

FIG. 4 illustrates a counter flow cyclone separator, generally designated 400. As shown, the counter flow cyclone separator 400 comprises an outer hollow cylindrical member 401, a hollow conical member 402, a separator inlet 403, and an inner hollow cylindrical member 404, e.g., an outlet tube. Outer hollow cylindrical member 401 includes a proximal end 416 and a distal end 417, and forms a wall defining an inner volume 406. The wall formed by the outer hollow cylindrical member 401 has an inner surface 407 and an outer surface 408. The proximal end 416 of outer hollow cylindrical member 401 is in open communication with hollow conical member 402. The distal end 417 of outer hollow tubular member 401 is limited, in part, by a laterally-extending top surface 405, also having an inner surface and an outer surface.

Outer hollow cylindrical member 401 is also in open communication with an inlet 403, which preferably is situated in a tangential manner with respect to the outer surface 408 of the outer hollow tubular member 401. In operation, the inlet 403 receives a catalyst containing stream from a reaction system in a tangential manner and forms an inner vortex, containing smaller components, formed about the longitudinally extending center axis a in inner volumes 406 and 413. The inlet also forms an outer vortex in inner volumes 406 and 413, containing larger catalyst particles. The outer vortex is coaxial with and surrounds the inner vortex and is coaxial with center axis α. The outer limits of the outer vortex are limited by the inner surface 407 of the outer hollow cylindrical member 401 and by the inner surface 407 of the hollow conical member 402.

As shown, the inner hollow tubular member 404 traverses the top surface 405 and extends into inner volume 406. The proximal end of the inner hollow tubular member 404 forms an opening 412 (e.g., the small stream outlet) adapted to receive an inner vortex formed in the counter flow cyclone separator 400, which is comprised of the lighter components received in the counter flow cyclone separator 400.

Hollow conical member 402 includes a broad distal end 415 and a narrow proximal end 414, and forms a wall defining inner volume 413. The wall formed by the conical member 402, which is continuous with the wall defined by the outer hollow cylindrical member 401, also has an inner surface 407 and an outer surface 408. Narrow proximal end 414 forms apex opening 411, through which the larger particulate materials, contained in the outer vortex, are yielded from the counter flow cyclone separator 400.

Hollow conical member 402 preferably defines a second inlet 409, which is in open communication with a turbulizing stream conduit 418. Turbulizing stream conduit 418 receives a turbulizing stream from a turbulizing stream source, not shown, and directs the turbulizing stream to second inlet 409. In operation, the turbulizing stream flows through the hollow conical member 402 and enters inner volume 413, thereby at least partially disrupting the downward flow of the outer vortex. In this manner, a portion of the lighter particulate components entrained in the outer vortex are removed therefrom and are transferred to the inner vortex for removal from the counter flow cyclone separator 400 via opening 412 and inner hollow cylindrical member 404. Turbulizing stream conduit 418 optionally includes a control valve 410 to control the flow rate of the turbulizing stream into the counter flow cyclone separator 400. Control of the particle size “cut” can be desirably achieved by modulation of the turbulizing stream flow rate into counter flow cyclone separator 400.

The process of the present invention for selectively removing undesirably-sized catalyst particles from a population of formulated molecular sieve catalyst composition particles provides the ability to create a mixture of catalyst particles having a desirable particle size distribution and/or median particle diameter in order to increase catalytic activity and maximize fluidization characteristics of the catalyst particles in an OTO reaction system. Thus, in one embodiment, the invention is to a mixture of catalyst particles which includes a plurality of formulated molecular sieve catalyst particles. Each formulated molecular sieve catalyst particle comprises a molecular sieve, a matrix material, and optionally a binder. The plurality of formulated molecular sieve catalyst particles has a d10 of at least about 5 microns and a d90 of no greater than about 300 microns. It has now been discovered that this mixture of catalyst particles provides desirable catalytic and fluidization characteristics for implementation in an OTO reaction system. Optionally, the d10 is at least about 10 microns, at least about 20 microns, or at least about 45 microns. The d90 is optionally is no greater than about 200 microns, no greater than about 150 microns, or no greater than about 120 microns. In one embodiment, the d10 is at least about 10 microns and the d90 is no greater than about 150 microns. In another embodiment, the d10 is at least about 20 microns and the d90 is no greater than about 120 microns.

In another embodiment, the present invention is directed to a process for providing molecular sieve catalyst particles having desirable size characteristics, wherein small catalyst particles are removed in a first separation step and large catalyst particles are removed in a second separation step. This inventive process includes the step of forming a slurry containing a molecular sieve, a matrix material, a slurring agent, and optionally a binder. At least a portion of the slurry is dried to produce a first plurality of catalyst particles having a first median particle diameter. A first portion of catalyst particles is selectively removed from the first plurality of catalyst particles to form a second plurality of catalyst particles having a second median particle diameter greater than the first median particle diameter. A second portion of catalyst particles is selectively removed the second plurality of catalyst particles to form a final plurality of catalyst particles having a final median particle diameter less than the second median particle diameter. Optionally, the first portion has a first d50 of no greater than about 45 microns, no greater than about 20 microns, or no greater than about 10 microns. The second portion optionally has a second d50 of at least about 120 microns, at least about 140 microns, or at least about 160 microns. Optionally, the final median particle diameter is from about 50 to about 100 microns, from about 60 to about 90 microns, or from about 65 to about 85 microns.

In the embodiments of the present invention that comprise two separation steps, for example, a first removal step for the removal of large catalyst particles and a second removal step for the removal of smaller catalyst particles, the present invention may implement one or two or more separation units. Optionally, the two separation steps occur in a single separation unit. In this embodiment, which is implemented well in a tunable counter flow cyclone separator, a first catalyst mixture is directed to a separation unit which removes a first portion of catalyst particles from the first catalyst mixture to form a second catalyst mixture. In the second separation step, the second catalyst mixture is redirected to the same separation unit, for removal of the second portion of catalyst particles from the second catalyst mixture. The same separation unit is capable of performing both separation steps by modulating the flow of the turbulizing stream into the tunable counter flow cyclone separator. In this manner, equipment count in the separation system can be advantageously reduced. In an alternative embodiment, two separate separation units perform the two separation steps, the first, the second, or both of which are counter flow cyclone separators.

In another embodiment of the present invention, larger catalyst particles are removed to the first separation step, followed by the removal of smaller catalyst particles in a second separation step. Specifically, the process includes a step of forming a slurry containing a molecular sieve, a matrix material, a slurring agent, and optionally a binder. At least a portion of the slurry is dried to produce a first plurality of catalyst particles having a first median particle diameter. A first portion of catalyst particles is selectively removed from the first plurality of catalyst particles to form a second plurality of catalyst particles having a second median particular diameter less than the first median particle diameter. A second portion of catalyst particles is selectively removed from the second plurality of catalyst particles to form a final plurality of catalyst particles having a final median particular diameter greater than the second median particle diameter. In this embodiment, the first portion optionally has a first d50 of at least about 120 microns, at least about 140 microns, or at least about 160 microns. The second portion optionally has a second d50 of no greater than about 50 microns, no greater than about 45 microns, no greater than about 40 microns, no greater than about 20 microns, or no greater than about 10 microns. In terms of ranges, the final median particle diameter optionally is from about 50 to about 100 microns, from about 60 to about 90 microns, or from about 65 to about 85 microns.

In another embodiment, the invention is to a process for producing light olefins, wherein the process includes the step of providing an oxygenate in an oxygenate containing feedstock, and providing a plurality of molecular sieve catalyst particles having a d10 of at least about 5 microns and a d90 of no greater than about 300 microns. The oxygenate contacts at least one of the molecular sieve catalyst particles under conditions effective to convert at least a portion of the oxygenate to light olefins. In this embodiment also, the d10 optionally is at least about 10 microns, at least about 20 microns, or at least about 45 microns. Optionally, the d90 is no greater than about 200 microns, no greater than about 150 microns, or no greater than about 120 microns. Optionally, the d10 is at least about 10 microns, and the d90 is no greater than about 150 microns, or the d10 is at least about 20 microns and the d90 is no greater than about 120 microns. Optionally, the plurality of catalyst particles has a median particle diameter of from about 50 to about 100 microns, from about 60 to about 90 microns, or from about 65 to about 85 microns. In this inventive embodiment, especially high selectivities to light olefins can be achieved. For example, in one embodiment, a selectivity to light olefins of at least about 70 weight percent, at least about 75 weight percent, or at least 78 weight percent can be achieved.

Molecular Sieves and Catalysts Thereof

Molecular sieves have various chemical, physical, and framework characteristics. Molecular sieves have been well classified by the Structure Commission of the International Zeolite Association according to the rules of the IUPAC Commission on Zeolite Nomenclature. A molecular sieve's “framework-type” describes the connectivity and topology of the tetrahedrally coordinated atoms constituting the framework, and makes an abstraction of the specific properties for those materials. Framework-type zeolite and zeolite-type molecular sieves for which a structure has been established are assigned a three letter code and are described in the Atlas of Zeolite Framework Types, 5th edition, Elsevier, London, England (2001), which is herein fully incorporated by reference.

Non-limiting examples of these molecular sieves are the small pore molecular sieves, AEI, AFT, APC, ATN, ATT, ATV, AWW, BIK, CAS, CHA, CHI, DAC, DDR, EDI, ERI, GOO, KFI, LEV, LOV, LTA, MON, PAU, PHI, RHO, ROG, THO, and substituted forms thereof; the medium pore molecular sieves, AFO, AEL, EUO, HEU, FER, MEL, MFI, MTW, MTT, TON, and substituted forms thereof; and the large pore molecular sieves, EMT, FAU, and substituted forms thereof. Other molecular sieves include ANA, BEA, CFI, CLO, DON, GIS, LTL, MER, MOR, MWW and SOD. Non-limiting examples of the preferred molecular sieves, particularly for converting an oxygenate containing feedstock into olefin(s), include AEL, AFY, BEA, CHA, EDI, FAU, FER, GIS, LTA, LTL, MER, MFI, MOR, MTT, MWW, TAM and TON. In one preferred embodiment, the molecular sieve of the invention has an AEI framework-type or a CHA framework-type, or a combination thereof, most preferably a CHA framework-type.

Molecular sieve materials all have 3-dimensional framework structure of corner-sharing TO4 tetrahedra, where T is any tetrahedrally coordinated cation. These molecular sieves are typically described in terms of the size of the ring that defines a pore, where the size is based on the number of T atoms in the ring. Other framework-type characteristics include the arrangement of rings that form a cage, and when present, the dimension of channels, and the spaces between the cages. See van Bekkum, et al., Introduction to Zeolite Science and Practice, Second Completely Revised and Expanded Edition, Volume 137, pages 1-67, Elsevier Science, B. V., Amsterdam, Netherlands (2001).

The small, medium and large pore molecular sieves have from a 4-ring to a 12-ring or greater framework-type. In a preferred embodiment, the zeolitic molecular sieves have 8-, 10- or 12-ring structures or larger and an average pore size in the range of from about 3 Å to 15 Å. In the most preferred embodiment, the molecular sieves of the invention, preferably silicoaluminophosphate molecular sieves, have 8-rings and an average pore size less than about 5 Å, preferably in the range of from 3 Å to about 5 Å, more preferably from 3 Å to about 4.5 Å, and most preferably from 3.5 Å to about 4.2 Å.

Molecular sieves, particularly zeolitic and zeolitic-type molecular sieves, preferably have a molecular framework of one, preferably two or more corner-sharing [TO4] tetrahedral units, more preferably, two or more [SiO4], [AlO4] and/or [PO4] tetrahedral units, and most preferably [SiO4], [AlO4] and [PO4] tetrahedral units. These silicon, aluminum, and phosphorous based molecular sieves and metal containing silicon, aluminum and phosphorous based molecular sieves have been described in detail in numerous publications including for example, U.S. Pat. No. 4,567,029 (MeAPO where Me is Mg, Mn, Zn, or Co), U.S. Pat. No. 4,440,871 (SAPO), European Patent Application EP-A-0 159 624 (ELAPSO where El is As, Be, B, Cr, Co, Ga, Ge, Fe, Li, Mg, Mn, Ti or Zn), U.S. Pat. No. 4,554,143 (FeAPO), U.S. Pat. Nos. 4,822,478, 4,683,217, 4,744,885 (FeAPSO), EP-A-0 158 975 and U.S. Pat. No. 4,935,216 (ZnAPSO), EP-A-0 161 489 (CoAPSO), EP-A-0 158 976 (ELAPO, where EL is Co, Fe, Mg, Mn, Ti or Zn), U.S. Pat. No. 4,310,440 (AlPO4), EP-A-0 158 350 (SENAPSO), U.S. Pat. No. 4,973,460 (LiAPSO), U.S. Pat. No. 4,789,535 (LiAPO), U.S. Pat. No. 4,992,250 (GeAPSO), U.S. Pat. No. 4,888,167 (GeAPO), U.S. Pat. No. 5,057,295 (BAPSO), U.S. Pat. No. 4,738,837 (CrAPSO), U.S. Pat. Nos. 4,759,919, and 4,851,106 (CrAPO), U.S. Pat. Nos. 4,758,419, 4,882,038, 5,434,326 and 5,478,787 (MgAPSO), U.S. Pat. No. 4,554,143 (FeAPO), U.S. Pat. No. 4,894,213 (AsAPSO), U.S. Pat. No. 4,913,888 (AsAPO), U.S. Pat. Nos. 4,686,092, 4,846,956 and 4,793,833 (MnAPSO), U.S. Pat. Nos. 5,345,011 and 6,156,931 (MnAPO), U.S. Pat. No. 4,737,353 (BeAPSO), U.S. Pat. No. 4,940,570 (BeAPO), U.S. Pat. Nos. 4,801,309, 4,684,617 and 4,880,520 (TiAPSO), U.S. Pat. Nos. 4,500,651, 4,551,236 and 4,605,492 (TiAPO), U.S. Pat. Nos. 4,824,554, 4,744,970 (CoAPSO), U.S. Pat. No. 4,735,806 (GaAPSO) EP-A-0 293 937 (QAPSO, where Q is framework oxide unit [QO2]), as well as U.S. Pat. Nos. 4,567,029, 4,686,093, 4,781,814, 4,793,984, 4,801,364, 4,853,197, 4,917,876, 4,952,384, 4,956,164, 4,956,165, 4,973,785, 5,241,093, 5,493,066 and 5,675,050, all of which are fully incorporated herein by reference. Other molecular sieves are described in R. Szostak, Handbook of Molecular Sieves, Van Nostrand Reinhold, New York, N.Y. (1992), which is fully incorporated herein by reference.

The more preferred silicon, aluminum and/or phosphorous containing molecular sieves, and aluminum, phosphorous, and optionally silicon, containing molecular sieves include aluminophosphate (ALPO) molecular sieves and silicoaluminophosphate (SAPO) molecular sieves and substituted, preferably metal substituted, ALPO and SAPO molecular sieves. The most preferred molecular sieves are SAPO molecular sieves, and metal substituted SAPO molecular sieves. In an embodiment, the metal is an alkali metal of Group IA of the Periodic Table of Elements, an alkaline earth metal of Group IIA of the Periodic Table of Elements, a rare earth metal of Group IIIB, including the Lanthanides: lanthanum, cerium, praseodymium, neodymium, samarium, europium, gadolinium, terbium, dysprosium, holmium, erbium, thulium, ytterbium and lutetium; and scandium or yttrium of the Periodic Table of Elements, a transition metal of Groups IVB, VB, VIIB, VIIB, VIIIB, and IB of the Periodic Table of Elements, or mixtures of any of these metal species. In one preferred embodiment, the metal is selected from the group consisting of Co, Cr, Cu, Fe, Ga, Ge, Mg, Mn, Ni, Sn, Ti, Zn and Zr, and mixtures thereof. In another preferred embodiment, these metal atoms discussed above are inserted into the framework of a molecular sieve through a tetrahedral unit, such as [MeO2], and carry a net charge depending on the valence state of the metal substituent. For example, in one embodiment, when the metal substituent has a valence state of +2, +3, +4, +5, or +6, the net charge of the tetrahedral unit is between −2 and +2.

In one embodiment, the molecular sieve, as described in many of the U.S. Patents mentioned above, is represented by the empirical formula, on an anhydrous basis:
mR:(MₓAl_{y}P_{z})O₂
   wherein R represents at least one templating agent, preferably an organic templating agent; m is the number of moles of R per mole of (MₓAl_{y}P_{z})O₂ and m has a value from 0 to 1, preferably 0 to 0.5, and most preferably from 0 to 0.3; x, y, and z represent the mole fraction of M, Al and P as tetrahedral oxides, where M is a metal selected from one of Group IA, IIA, IB, IIIB, IVB, VB, VIB, VIIB, VIIIB and Lanthamide's of the Periodic Table of Elements, preferably M is selected from one of the group consisting of Co, Cr, Cu, Fe, Ga, Ge, Mg, Mn, Ni, Sn, Ti, Zn and Zr. In an embodiment, m is greater than or equal to 0.2, and x, y and z are greater than or equal to 0.01. In another embodiment, m is greater than 0.1 to about 1, x is greater than 0 to about 0.25, y is in the range of from 0.4 to 0.5, and z is in the range of from 0.25 to 0.5, more preferably m is from 0.15 to 0.7, x is from 0.01 to 0.2, y is from 0.4 to 0.5, and z is from 0.3 to 0.5.

Non-limiting examples of SAPO and ALPO molecular sieves of the invention include one or a combination of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44 (U.S. Pat. No. 6,162,415), SAPO-47, SAPO-56, ALPO-5, ALPO-11, ALPO-18, ALPO-31, ALPO-34, ALPO-36, ALPO-37, ALPO-46, and metal containing molecular sieves thereof. Preferably, the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, the metal containing forms thereof, and mixtures thereof. The more preferred zeolite-type molecular sieves include one or a combination of SAPO-18, SAPO-34, SAPO-35, SAPO-44, SAPO-56, ALPO-18 and ALPO-34, even more preferably one or a combination of SAPO-18, SAPO-34, ALPO-34 and ALPO-18, and metal containing molecular sieves thereof, and most preferably one or a combination of SAPO-34 and ALPO-18, and metal containing molecular sieves thereof. Optionally, the molecular sieve is selected from the group consisting of SAPO-34, the metal containing forms thereof, and mixtures thereof.

In an embodiment, the molecular sieve is an intergrowth material having two or more distinct phases of crystalline structures within one molecular sieve composition. In particular, intergrowth molecular sieves are described in the U.S. patent application Ser. No. 09/924,016 filed Aug. 7, 2001 and PCT WO 98/15496 published Apr. 16, 1998, both of which are herein fully incorporated by reference. For example, SAPO-18, ALPO-18 and RUW-18 have an AEI framework-type, and SAPO-34 has a CHA framework-type. In another embodiment, the molecular sieve comprises at least one intergrown phase of AEI and CHA framework-types, preferably the molecular sieve has a greater amount of CHA framework-type to AEI framework-type, and more preferably the molar ratio of CHA to AEI is greater than 1:1.

Molecular Sieve Synthesis

The synthesis of molecular sieves is described in many of the references discussed above. Generally, molecular sieves are synthesized by the hydrothermal crystallization of one or more of a source of aluminum, a source of phosphorous, a source of silicon, a templating agent, and a metal containing compound. Typically, a combination of sources of silicon, aluminum and phosphorous, optionally with one or more templating agents and/or one or more metal containing compounds are placed in a sealed pressure vessel, optionally lined with an inert plastic such as polytetrafluoroethylene, and heated, under a crystallization pressure and temperature, until a crystalline molecular sieve material is formed, and then recovered by filtration, centrifugation and/or decanting.

In a preferred embodiment, the molecular sieves are synthesized by forming a reaction product of a source of silicon, a source of aluminum, a source of phosphorous, and/or an organic templating agent, preferably a nitrogen containing organic templating agent. This particularly preferred embodiment results in the synthesis of a silicoaluminophosphate crystalline material that is then isolated by filtration, centrifugation and/or decanting.

Non-limiting examples of silicon sources include silicates, filmed silica, for example, Aerosil-200 available from Degussa Inc., New York, N.Y., and CAB-O-SIL M-5, silicon compounds such as tetraalkyl orthosilicates, for example, tetramethyl orthosilicate (TMOS) and tetraethylorthosilicate (TEOS), colloidal silicas or aqueous suspensions thereof, for example Ludox-HS-40 sol available from E.I. du Pont de Nemours, Wilmington, Del., silicic acid, alkali-metal silicate, or any combination thereof. The preferred source of silicon is a silica sol.

Non-limiting examples of aluminum sources include aluminum-containing compositions such as aluminum alkoxides, for example aluminum isopropoxide, aluminum phosphate, aluminum hydroxide, sodium aluminate, pseudo-boehmite, gibbsite and aluminum trichloride, or any combinations thereof. A preferred source of aluminum is pseudo-boehmite, particularly when producing a silicoaluminophosphate molecular sieve.

Non-limiting examples of phosphorous sources, which may also include aluminum-containing phosphorous compositions, include phosphorous-containing, inorganic or organic, compositions such as phosphoric acid, organic phosphates such as triethyl phosphate, and crystalline or amorphous aluminophosphates such as ALPO4, phosphorous salts, or combinations thereof. The preferred source of phosphorous is phosphoric acid, particularly when producing a silicoaluminophosphate.

Templating agents are generally compounds that contain elements of Group VA of the Periodic Table of Elements, particularly nitrogen, phosphorus, arsenic and antimony, more preferably nitrogen or phosphorous, and most preferably nitrogen. Typical templating agents of Group VA of the Periodic Table of elements also contain at least one alkyl or aryl group, preferably an alkyl or aryl group having from 1 to 10 carbon atoms, and more preferably from 1 to 8 carbon atoms. The preferred templating agents are nitrogen-containing compounds such as amines and quaternary ammonium compounds.

The quaternary ammonium compounds, in one embodiment, are represented by the general formula R4N+, where each R is hydrogen or a hydrocarbyl or substituted hydrocarbyl group, preferably an alkyl group or an aryl group having from 1 to 10 carbon atoms. In one embodiment, the templating agents include a combination of one or more quaternary ammonium compound(s) and one or more of a mono-, di- or tri-amine.

Non-limiting examples of templating agents include tetraalkyl ammonium compounds including salts thereof such as tetramethyl ammonium compounds including salts thereof, tetraethyl ammonium compounds including salts thereof, tetrapropyl ammonium including salts thereof, and tetrabutylammonium including salts thereof, cyclohexylamine, morpholine, di-n-propylamine (DPA), tripropylamine, triethylamine (TEA), triethanolamine, piperidine, cyclohexylamine, 2-methylpyridine, N,N-dimethylbenzylamine, N,N-diethylethanolamine, dicyclohexylamine, N,N-dimethylethanolamine, choline, N,N′-dimethylpiperazine, 1,4-diazabicyclo(2,2,2)octane, N′,N′,N,N-tetramethyl(1,6)hexanediamine, N-methyldiethanolamine, N-methyl-ethanolamine, N-methyl piperidine, 3-methyl-piperidine, N-methylcyclohexylamine, 3-methylpyridine, 4-methyl-pyridine, quinuclidine, N,N′-dimethyl-1,4-diazabicyclo(2,2,2) octane ion; di-n-butylamine, neopentylamine, di-n-pentylamine, isopropylamine, t-butylamine, ethylenediamine, pyrrolidine, polyethylenimine and 2-imidazolidone.

The preferred templating agent or template is a tetraethylammonium compound, such as tetraethyl ammonium hydroxide (TEAOH), tetraethyl ammonium phosphate, tetraethyl ammonium fluoride, tetraethyl ammonium bromide, tetraethyl ammonium chloride and tetraethyl ammonium acetate. The most preferred templating agent is tetraethyl ammonium hydroxide and salts thereof, particularly when producing a silicoaluminophosphate molecular sieve. In one embodiment, a combination of two or more of any of the above templating agents is used in combination with one or more of a silicon-, aluminum-, and phosphorous-source.

A synthesis mixture containing at a minimum a silicon-, aluminum- and/or phosphorous-composition, and a templating agent, should have a pH in the range of from 2 to 10, preferably in the range of from 4 to 9, and most preferably in the range of from 5 to 8. Generally, the synthesis mixture is sealed in a vessel and heated, preferably under autogenous pressure, to a temperature in the range of from about 80° C. to about 250° C., and more preferably from about 150° C. to about 180° C. The time required to form the crystalline product is typically from immediately up to several weeks, the duration of which is usually dependent on the temperature; the higher the temperature the shorter the duration. Typically, the crystalline molecular sieve product is formed, usually in a slurry state, and is recovered by any standard technique well known in the art, for example centrifugation or filtration. The isolated or separated crystalline product, in an embodiment, is washed, typically, using a liquid such as water, from one to many times. The washed crystalline product is then optionally dried, preferably in air.

Molecular sieves have either a high silicon (Si) to aluminum (Al) atomic ratio or a low silicon to aluminum atomic ratio, however, a low Si/Al ratio is preferred for SAPO synthesis. In one embodiment, the molecular sieve has a Si/Al ratio less than 0.65, preferably less than 0.40, more preferably less than 0.32, and most preferably less than 0.20. In another embodiment the molecular sieve has a Si/Al ratio in the range of from about 0.65 to about 0.10, preferably from about 0.40 to about 0.10, more preferably from about 0.32 to about 0.10, and more preferably from about 0.32 to about 0.15.

Forming Molecular Sieve Catalyst Compositions

Once the molecular sieve is synthesized as described above, depending on the requirements of the particular conversion process, the molecular sieve is then formulated into a molecular sieve catalyst composition as described in more detail below. The molecular sieves synthesized above are made or formulated into molecular sieve catalyst compositions by combining the synthesized molecular sieve(s) with one or more matrix materials and optionally a binder to form a formulation composition.

Matrix materials are typically effective in reducing overall catalyst cost, act as thermal sinks assisting in shielding heat from the catalyst composition for example during regeneration, densifying the catalyst composition, increasing catalyst strength such as crush strength and attrition resistance, and to control the rate of conversion in a particular process.

Non-limiting examples of matrix materials include one or more of: rare earth metals, non-active, metal oxides including titania, zirconia, magnesia, thoria, beryllia, quartz, silica or sols, and mixtures thereof, for example silica-magnesia, silica-zirconia, silica-titania, silica-alumina and silica-alumina-thoria. In an embodiment, matrix materials are natural clays such as those from the families of montmorillonite and kaolin. These natural clays include kaolins known as, for example, Dixie, McNamee, Georgia and Florida clays. Non-limiting examples of other matrix materials include: haloysite, kaolinite, dickite, nacrite, or anauxite. In one embodiment, the matrix material, preferably any of the clays, are subjected to well known modification processes such as calcination and/or acid treatment and/or chemical treatment.

In one preferred embodiment, the matrix material is a clay or a clay-type composition, preferably the clay or clay-type composition having a low iron, cobalt, nickel, titanium, palladium, chromium and/or platinum content, and most preferably the matrix material is kaolin. Kaolin has been found to form a pumpable, high solid content slurry, it has a low fresh surface area, and it packs together easily due to its platelet structure. A preferred average particle size of the matrix material, most preferably kaolin, is from about 0.1 μm to about 0.6 μm with a d90 particle size distribution of less than about 1 μm.

As indicated above, once the molecular sieve is synthesized, depending on the requirements of the particular conversion process, the molecular sieve is then formulated into a molecular sieve catalyst composition as described in more detail below. The molecular sieves synthesized above are made or formulated into molecular sieve catalyst compositions by combining the synthesized molecular sieve(s) with a matrix material and optionally a binder to form a formulation composition. This formulation composition is formed into useful shape and sized particles by well-known techniques such as spray drying, pelletizing, extrusion, and the like, spray drying being the most preferred. It is also preferred that after spray drying for example that the formulation composition is then calcined.

In one embodiment, the weight ratio of the binder to the molecular sieve is in the range of from about 0.1 to 0.5, preferably in the range of from 0.1 to less than 0.5, more preferably in the range of from 0.11 to 0.48, even more preferably from 0.12 to about 0.45, yet even more preferably from 0.13 to less than 0.45, and most preferably in the range of from 0.15 to about 0.4. In another embodiment, the weight ratio of the binder to the molecular sieve is in the range of from 0.11 to 0.45, preferably in the range of from about 0.12 to less than 0.40, more preferably in the range of from 0.15 to about 0.35, and most preferably in the range of from 0.2 to about 0.3. All values between these ranges are included in this patent specification.

In another embodiment, the molecular sieve catalyst composition or formulated molecular sieve catalyst composition has a micropore surface area (MSA) measured in m2/g-molecular sieve that is about 70 percent, preferably about 75 percent, more preferably 80 percent, even more preferably 85 percent, and most preferably about 90 percent of the MSA of the molecular sieve itself. The MSA of the molecular sieve catalyst composition is the total MSA of the composition divided by the fraction of the molecular sieve contained in the molecular sieve catalyst composition.

There are many different binders that are useful in forming the molecular sieve catalyst composition. Non-limiting examples of binders that are useful alone or in combination include various types of hydrated alumina, silicas, and/or other inorganic oxide sol. One preferred alumina containing sol is aluminum chlorhydrate. The inorganic oxide sol acts like glue binding the synthesized molecular sieves and other materials such as the matrix together, particularly after thermal treatment. Upon heating, the inorganic oxide sol, preferably having a low viscosity, is converted into an inorganic oxide matrix component. For example, an alumina sol will convert to an aluminum oxide matrix following heat treatment.

Aluminum chlorhydrate, a hydroxylated aluminum based sol containing a chloride counter ion, has the general formula of AlₘOₙ(OH)ₒClₚ.x(H₂O) wherein m is 1 to 20, n is 1 to 8, o is 5 to 40, p is 2 to 15, and x is 0 to 30. In one embodiment, the binder is Al₁₃O₄(OH)₂₄C₁₇.12(H₂O) as is described in G. M. Wolterman, et al., Stud. Surf. Sci. and Catal., 76, pages 105-144 (1993), which is herein incorporated by reference. In another embodiment, one or more binders are combined with one or more other non-limiting examples of alumina materials such as aluminum oxyhydroxide, γ-alumina, boehmite, diaspore, and transitional aluminas such as α-alumina, β-alumina, γ-alumina, δ-alumina, ε-alumina, κ-alumina, and ρ-alumina, aluminum trihydroxide, such as gibbsite, bayerite, nordstrandite, doyelite, and mixtures thereof.

In another embodiment, the binders are alumina sols, predominantly comprising aluminum oxide, optionally including some silicon. In yet another embodiment, the binders are peptized alumina made by treating alumina hydrates such as pseudobohemite, with an acid, preferably an acid that does not contain a halogen, to prepare sols or aluminum ion solutions. Non-limiting examples of commercially available colloidal alumina sols include Nalco 8676 available from Nalco Chemical Co., Naperville, Ill., and Nyacol AL20DW, available from Nyacol Nano Technologies, Inc., Ashland, Mass.

In one embodiment, the binder, the synthesized molecular sieve and the matrix material are combined in the presence of a liquid slurrying medium such as water to form a molecular sieve catalyst composition, where the amount of binder is from about 2% by weight to about 30% by weight, preferably from about 5% by weight to about 25% by weight, and more preferably from about 7% by weight to about 22% by weight, based on the total weight of the binder, the molecular sieve and matrix material, excluding the liquid.

Upon combining the synthesized molecular sieve and the matrix material, optionally with a binder, in a liquid to form a slurry, mixing, preferably rigorous mixing is needed to produce a substantially homogeneous mixture containing the synthesized molecular sieve. Non-limiting examples of suitable liquid slurrying mediums include one or a combination of water, alcohol, ketones, aldehydes, and/or esters. The most preferred liquid is water. In one embodiment, the slurry is colloid-milled for a period of time sufficient to produce the desired slurry texture, sub-particle size, and/or sub-particle size distribution.

The liquid containing synthesized molecular sieve and matrix material, and the optional binder, are in the same or different liquid, and are combined in any order, together, simultaneously, sequentially, or a combination thereof. In the preferred embodiment, the same liquid, preferably water is used.

The molecular sieve catalyst composition in a preferred embodiment is made by preparing a slurry containing a molecular sieve, a matrix material and a binder. The solids content of the preferred slurry includes from about 10% to about 90% by weight molecular sieve, preferably from about 20% to about 75% by weight molecular sieve, more preferably from about 25% to about 70% by weight molecular sieve, from about 5% to about 30%, preferably from about 7% to about 22%, by weight of binder, and about 10% to about 90%, preferably about 15% to about 80%, by weight matrix material.

In another most preferred embodiment, the solids content in a slurry comprising a molecular sieve, a binder, and optionally a matrix material, and a liquid medium is in the range of from about 20 weight percent to about 80 weight percent, more preferably in the range of from 30 weight percent to about 70 weight percent, even more preferably in the range of from 35 weight percent to 60 weight percent, still even more preferably from about 36 weight percent to about 50 weight percent, yet even more preferably in the range of from 37 weight percent to about 45 weight percent, and most preferably in the range of from 38 weight percent to about 45 weight percent.

As the slurry is mixed, the solids in the slurry aggregate preferably to a point where the slurry contains solid molecular sieve catalyst composition particles. It is preferable that these particles are small and have a uniform size distribution such that the d90 diameter of these particles is less than 20 μm, more preferably less than 15 μm, and most preferably less than 10 μm. In one embodiment, the slurry of the invention contains at least 90 percent by volume of the molecular sieve catalyst composition particles, each comprising molecular sieve, optionally binder, and matrix material, and having a diameter of less than 20 μm, preferably less than 15 μm, and most preferably less than 10 μm.

In one preferred embodiment the slurry comprises a liquid portion and solid portion, wherein the solid portion comprises solid particles, the solid particles comprising a molecular sieve, a binder and a matrix material; wherein the slurry contains in the range of from about 30 weight percent to about 50 weight percent solid particles, preferably from about 35 weight percent to 45 weight percent, and at least 90 percent of the solid particles having a diameter less than 20 μm, preferably less than 10 μm.

In one embodiment, the slurry of the synthesized molecular sieve, binder and matrix material is mixed or milled to achieve a sufficiently uniform slurry of sub-particles of the molecular sieve catalyst composition to form a formulation composition that is then fed to a forming unit that produces the molecular sieve catalyst composition or formulated molecular sieve catalyst composition. In a preferred embodiment, the forming unit is spray dryer. Typically, the forming unit is maintained at a temperature sufficient to remove most of the liquid from the slurry, and from the resulting molecular sieve catalyst composition. The resulting catalyst composition when formed in this way takes the form of microspheres.

When a spray drier is used as the forming unit, typically, any one or a combination of the slurries described above, more particularly a slurry of the synthesized molecular sieve, matrix material, and binder, is co-fed to the spray dryer with a drying gas with an average inlet temperature ranging from 200° C. to 550° C., and a combined outlet temperature ranging from 100° C. to about 225° C. In an embodiment, the average diameter of the spray dried formed catalyst composition is from about 40 μm to about 300 μm, preferably from about 50 μm to about 250 μm, more preferably from about 50 μm to about 200 μm, and most preferably from about 65 μm to about 90 μm.

During spray drying, the slurry is passed through a nozzle distributing the slurry into small droplets, resembling an aerosol spray, and into a drying chamber. Atomization is achieved by forcing the slurry through a single nozzle or multiple nozzles with a pressure drop in the range of from 100 psig to 2000 psig (690 kPag to 13790 kPag), preferably from 100 psig to 1000 psig (690 kPag to 6895 kPag). In another embodiment, the slurry is co-fed through a single nozzle or multiple nozzles along with an atomization fluid such as air, steam, flue gas, or any other suitable gas with a pressure drop preferably in the range of from 1 psig to 150 psig (6.9 kPag to 1034 kPag).

In yet another embodiment, the slurry described above is directed to the perimeter of a spinning wheel that distributes the slurry into small droplets, the size of which is controlled by many factors including slurry viscosity, surface tension, flow rate, pressure, and temperature of the slurry, the shape and dimension of the nozzle(s), or the spinning rate of the wheel. These droplets are then dried in a co-current or counter-current flow of air passing through a spray drier to form a substantially dried or dried molecular sieve catalyst composition, more specifically a molecular sieve composition in a powder or a microsphere form.

Generally, the size of the microspheres is controlled to some extent by the solids content of the slurry. However, control of the size of the catalyst composition and its spherical characteristics are controllable by varying the slurry feed properties and conditions of atomization. In one embodiment, the catalyst composition has a d50 particle size from about 20 to about 200 microns.

Other processes for forming a molecular sieve catalyst composition are described in U.S. patent application Ser. No. 09/617,714 filed Jul. 17, 2000 (spray drying using a recycled molecular sieve catalyst composition), which is herein incorporated by reference.

In another embodiment, the formulated molecular sieve catalyst composition contains from about 1% to about 99%, preferably from about 10% to about 90%, more preferably from about 10% to about 80%, even more preferably from about 20% to about 70%, and most preferably from about 25% to about 60% by weight of the molecular sieve based on the total weight of the molecular sieve catalyst composition.

Once the molecular sieve catalyst composition is formed in a substantially dry or dried state, to further harden and/or activate the formed catalyst composition, a heat treatment such as calcination, at an elevated temperature is preferably performed. A conventional calcination environment is air that typically includes a small amount of water vapor. Typical calcination temperatures are in the range from about 400° C. to about 1,000° C., preferably from about 500° C. to about 800° C., and most preferably from about 550° C. to about 700° C., preferably in a calcination environment such as air, nitrogen, helium, flue gas (combustion product lean in oxygen), or any combination thereof. In one embodiment, calcination of the formulated molecular sieve catalyst composition is carried out in any number of well known devices including rotary calciners, fluid bed calciners, batch ovens, and the like. Calcination time is typically dependent on the degree of hardening of the molecular sieve catalyst composition and the temperature ranges from about 15 minutes to about 20 hours. In a preferred embodiment, the molecular sieve catalyst composition is heated in nitrogen at a temperature of from about 600° C. to about 700° C. Heating is carried out for a period of time typically from 15 minutes to 15 hours, preferably from 30 minutes to about 10 hours, more preferably from about 30 minutes to about 5 hours.

In one embodiment, the attrition resistance of a molecular sieve catalyst composition is measured using an Attrition Rate Index (ARI), measured in weight percent catalyst composition attrited per hour. ARI is measured by adding 6.0 g of catalyst composition having a particles size ranging from 53 microns to 125 microns to a hardened steel attrition cup. Approximately 23,700 cc/min of nitrogen gas is bubbled through a water-containing bubbler to humidify the nitrogen. The wet nitrogen passes through the attrition cup, and exits the attrition apparatus through a porous fiber thimble. The flowing nitrogen removes the finer particles, with the larger particles being retained in the cup. The porous fiber thimble separates the fine catalyst particles from the nitrogen that exits through the thimble. The fine particles remaining in the thimble represent the catalyst composition that has broken apart through attrition. The nitrogen flow passing through the attrition cup is maintained for 1 hour. The fines collected in the thimble are removed from the unit. A new thimble is then installed. The catalyst left in the attrition unit is attrited for an additional 3 hours, under the same gas flow and moisture levels. The fines collected in the thimble are recovered. The collection of fine catalyst particles separated by the thimble after the first hour are weighed. The amount in grams of fine particles divided by the original amount of catalyst charged to the attrition cup expressed on per hour basis is the ARI, in weight percent per hour (wt. %/hr). ARI is represented by the formula: ARI=C/(B+C)/D multiplied by 100%, wherein B is weight of catalyst composition left in the cup after the attrition test, C is the weight of collected fine catalyst particles after the first hour of attrition treatment, and D is the duration of treatment in hours after the first hour attrition treatment.

In one embodiment, the molecular sieve catalyst composition or formulated molecular sieve catalyst composition has an ARI less than 15 weight percent per hour, preferably less than 10 weight percent per hour, more preferably less than 5 weight percent per hour, and even more preferably less than 2 weight percent per hour, and most preferably less than 1 weight percent per hour. In one embodiment, the molecular sieve catalyst composition or formulated molecular sieve catalyst composition has an ARI in the range of from 0 weight percent per hour to less than 5 weight percent per hour, more preferably from about 0.05 weight percent per hour to less than 3 weight percent per hour, and most preferably from about 0.01 weight percent per hour to less than 2 weight percent per hour.

In one preferred embodiment of the invention, the molecular sieve catalyst composition or formulated molecular sieve catalyst composition comprises a synthesized molecular sieve in an amount of from 20 weight percent to 60 weight percent, a binder in an amount of from 5 to 50 weight percent, and a matrix material in an amount of from 0 to 78 weight percent based on the total weight of the catalyst composition, upon calcination, and the catalyst composition having weight ratio of binder to sieve of from 0.1 to less than 0.5. In addition, the catalyst composition of this embodiment has an MSA on a contained sieve basis of the molecular sieve by itself from 450 m2/g-molecular sieve to 550 m2/g-molecular sieve, and/or an ARI less than 2 weight percent per hour.

According to the present invention, a population of formulated molecular sieve catalyst composition particles is directed to a separation system, described in detail above with references to FIGS. 1-3. In the separation system, undesirably sized catalyst particles are removed, in one, two, or more than two separation steps from the population of formulated molecular sieve catalyst composition particles.

Processes for Using Molecular Sieve Catalyst Compositions

The molecular sieve catalyst compositions or formulated molecular sieve catalyst compositions described above are useful in a variety of processes including: cracking, of for example a naphtha feed to light olefin(s) (U.S. Pat. No. 6,300,537) or higher molecular weight (MW) hydrocarbons to lower MW hydrocarbons; hydrocracking, of for example heavy petroleum and/or cyclic feedstock; isomerization, of for example aromatics such as xylene, polymerization, of for example one or more olefin(s) to produce a polymer product; reforming; hydrogenation; dehydrogenation; dewaxing, of for example hydrocarbons to remove straight chain paraffins; absorption, of for example alkyl aromatic compounds for separating out isomers thereof; alkylation, of for example aromatic hydrocarbons such as benzene and alkyl benzene, optionally with propylene to produce cumeme or with long chain olefins; transalkylation, of for example a combination of aromatic and polyalkylaromatic hydrocarbons; dealkylation; hydrodecylization; disproportionation, of for example toluene to make benzene and paraxylene; oligomerization, of for example straight and branched chain olefin(s); and dehydrocyclization.

Preferred processes are conversion processes including: naphtha to highly aromatic mixtures; light olefin(s) to gasoline, distillates and lubricants; oxygenates to olefin(s); light paraffins to olefins and/or aromatics; and unsaturated hydrocarbons (ethylene and/or acetylene) to aldehydes for conversion into alcohols, acids and esters. The most preferred process of the invention is a process directed to the conversion of a feedstock comprising one or more oxygenates to one or more olefin(s).

The molecular sieve catalyst compositions described above are particularly useful in conversion processes of different feedstock. Typically, the feedstock contains one or more aliphatic-containing compounds that include alcohols, amines, carbonyl compounds for example aldehydes, ketones and carboxylic acids, ethers, halides, mercaptans, sulfides, and the like, and mixtures thereof. The aliphatic moiety of the aliphatic-containing compounds typically contains from 1 to about 50 carbon atoms, preferably from 1 to 20 carbon atoms, more preferably from 1 to 10 carbon atoms, and most preferably from 1 to 4 carbon atoms.

Non-limiting examples of aliphatic-containing compounds include: alcohols such as methanol and ethanol, alkyl-mercaptans such as methyl mercaptan and ethyl mercaptan, alkyl-sulfides such as methyl sulfide, alkyl-amines such as methyl amine, alkyl-ethers such as dimethyl ether, diethyl ether and methylethyl ether, alkyl-halides such as methyl chloride and ethyl chloride, alkyl ketones such as dimethyl ketone, formaldehydes, and various acids such as acetic acid.

In a preferred embodiment of the process of the invention, the feedstock contains one or more oxygenates, more specifically, one or more organic compound(s) containing at least one oxygen atom. In the most preferred embodiment of the process of invention, the oxygenate in the feedstock is one or more alcohol(s), preferably aliphatic alcohol(s) where the aliphatic moiety of the alcohol(s) has from 1 to 20 carbon atoms, preferably from 1 to 10 carbon atoms, and most preferably from 1 to 4 carbon atoms. The alcohols useful as feedstock in the process of the invention include lower straight and branched chain aliphatic alcohols and their unsaturated counterparts.

Non-limiting examples of oxygenates include methanol, ethanol, n-propanol, isopropanol, methyl ethyl ether, dimethyl ether, diethyl ether, diisopropyl ether, formaldehyde, dimethyl carbonate, dimethyl ketone, acetic acid, and mixtures thereof. In the most preferred embodiment, the feedstock is selected from one or more of methanol, ethanol, dimethyl ether, diethyl ether or a combination thereof, more preferably methanol and dimethyl ether, and most preferably methanol.

The various feedstocks discussed above, particularly a feedstock containing an oxygenate, more particularly a feedstock containing an alcohol, is converted primarily into one or more olefin(s). The olefin(s) or olefin monomer(s) produced from the feedstock typically have from 2 to 30 carbon atoms, preferably 2 to 8 carbon atoms, more preferably 2 to 6 carbon atoms, still more preferably 2 to 4 carbons atoms, and most preferably ethylene an/or propylene. Non-limiting examples of olefin monomer(s) include ethylene, propylene, butene-1, pentene-1,4-methyl-pentene-1, hexene-1, octene-1 and decene-1, preferably ethylene, propylene, butene-1, pentene-1,4-methyl-pentene-1, hexene-1, octene-1 and isomers thereof. Other olefin monomer(s) include unsaturated monomers, diolefins having 4 to 18 carbon atoms, conjugated or nonconjugated dienes, polyenes, vinyl monomers and cyclic olefins.

In the most preferred embodiment, the feedstock, preferably of one or more oxygenates, is converted in the presence of a molecular sieve catalyst composition of the invention into olefin(s) having 2 to 6 carbons atoms, preferably 2 to 4 carbon atoms. Most preferably, the olefin(s), alone or combination, are converted from a feedstock containing an oxygenate, preferably an alcohol, most preferably methanol, to the preferred olefin(s) ethylene and/or propylene.

There are many processes used to convert feedstock into olefin(s) including various cracking processes such as steam cracking, thermal regenerative cracking, fluidized bed cracking, fluid catalytic cracking, deep catalytic cracking, and visbreaking. The most preferred process is generally referred to as gas-to-olefins (GTO) or alternatively, methanol-to-olefins (MTO). In a GTO process, typically natural gas is converted into a synthesis gas that is converted into an oxygenated feedstock, preferably containing methanol, where the oxygenated feedstock is converted in the presence of a molecular sieve catalyst composition into one or more olefin(s), preferably ethylene and/or propylene. In a MTO process, typically an oxygenated feedstock, most preferably a methanol containing feedstock, is converted in the presence of a molecular sieve catalyst composition thereof into one or more olefin(s), preferably and predominantly, ethylene and/or propylene, often referred to as light olefin(s).

In one embodiment of the process for conversion of a feedstock, preferably a feedstock containing one or more oxygenates, the amount of olefin(s) produced based on the total weight of hydrocarbon produced is greater than 50 weight percent, preferably greater than 60 weight percent, more preferably greater than 70 weight percent, and most preferably greater than 75 weight percent. In another embodiment of the process for conversion of one or more oxygenates to one or more olefin(s), the amount of ethylene and/or propylene produced based on the total weight of hydrocarbon product produced is greater than 65 weight percent, preferably greater than 70 weight percent, more preferably greater than 75 weight percent, and most preferably greater than 78 weight percent.

In another embodiment of the process for conversion of one or more oxygenates to one or more olefin(s), the amount ethylene produced in weight percent based on the total weight of hydrocarbon product produced, is greater than 30 weight percent, more preferably greater than 35 weight percent, and most preferably greater than 40 weight percent. In yet another embodiment of the process for conversion of one or more oxygenates to one or more olefin(s), the amount of propylene produced in weight percent based on the total weight of hydrocarbon product produced is greater than 20 weight percent, preferably greater than 25 weight percent, more preferably greater than 30 weight percent, and most preferably greater than 35 weight percent.

The feedstock, in one embodiment, contains one or more diluent(s), typically used to reduce the concentration of the feedstock, and are generally non-reactive to the feedstock or molecular sieve catalyst composition. Non-limiting examples of diluents include helium, argon, nitrogen, carbon monoxide, carbon dioxide, water, essentially non-reactive paraffins (especially alkanes such as methane, ethane, and propane), essentially non-reactive aromatic compounds, and mixtures thereof. The most preferred diluents are water and nitrogen, with water being particularly preferred.

The diluent, water, is used either in a liquid or a vapor form, or a combination thereof. The diluent is either added directly to a feedstock entering into a reactor or added directly into a reactor, or added with a molecular sieve catalyst composition. In one embodiment, the amount of diluent in the feedstock is in the range of from about 1 to about 99 mole percent based on the total number of moles of the feedstock and diluent, preferably from about 1 to 80 mole percent, more preferably from about 5 to about 50, and most preferably from about 5 to about 25.

In one embodiment, other hydrocarbons are added to a feedstock either directly or indirectly, and include olefin(s), paraffin(s), aromatic(s) (see for example U.S. Pat. No. 4,677,242, addition of aromatics) or mixtures thereof, preferably propylene, butylene, pentylene, and other hydrocarbons having 4 or more carbon atoms, or mixtures thereof.

The process for converting a feedstock, especially a feedstock containing one or more oxygenates, in the presence of a molecular sieve catalyst composition of the invention, is carried out in a reaction process in a reactor, where the process is a fixed bed process, a fluidized bed process (includes a turbulent bed process), preferably a continuous fluidized bed process, and most preferably a continuous high velocity fluidized bed process.

The reaction processes can take place in a variety of catalytic reactors such as hybrid reactors that have a dense bed or fixed bed reaction zones and/or fast fluidized bed reaction zones coupled together, circulating fluidized bed reactors, riser reactors, and the like. Suitable conventional reactor types are described in for example U.S. Pat. No. 4,076,796, U.S. Pat. No. 6,287,522 (dual riser), and Fluidization Engineering, D. Kunii and O. Levenspiel, Robert E. Krieger Publishing Company, New York, N.Y. 1977, which are all herein fully incorporated by reference. The preferred reactor type are riser reactors generally described in Riser Reactor, Fluidization and Fluid-Particle Systems, pages 48 to 59, F. A. Zenz and D. F. Othmo, Reinhold Publishing Corporation, New York, 1960, and U.S. Pat. No. 6,166,282 (fast-fluidized bed reactor), and U.S. patent application Ser. No. 09/564,613 filed May 4, 2000 (multiple riser reactor), which are all herein fully incorporated by reference.

In the preferred embodiment, a fluidized bed process or high velocity fluidized bed process includes a reactor system, a regeneration system and a recovery system.

The reactor system preferably is a fluid bed reactor system having a first reaction zone within one or more riser reactor(s) and a second reaction zone within at least one disengaging vessel, preferably comprising one or more cyclones. In one embodiment, the one or more riser reactor(s) and disengaging vessel is contained within a single reactor vessel. Fresh feedstock, preferably containing one or more oxygenates, optionally with one or more diluent(s), is fed to the one or more riser reactor(s) in which a molecular sieve catalyst composition or coked version thereof is introduced. In one embodiment, the molecular sieve catalyst composition or coked version thereof is contacted with a liquid or gas, or combination thereof, prior to being introduced to the riser reactor(s), preferably the liquid is water or methanol, and the gas is an inert gas such as nitrogen.

In an embodiment, the amount of liquid feedstock fed separately or jointly with a vapor feedstock, to a reactor system is in the range of from 0.1 weight percent to about 85 weight percent, preferably from about 1 weight percent to about 75 weight percent, more preferably from about 5 weight percent to about 65 weight percent based on the total weight of the feedstock including any diluent contained therein. The liquid and vapor feedstocks are preferably of similar or the same composition, or contain varying proportions of the same or different feedstock with the same or different diluent.

The feedstock entering the reactor system is preferably converted, partially or fully, in the first reactor zone into a gaseous effluent that enters the disengaging vessel along with a coked molecular sieve catalyst composition. In the preferred embodiment, cyclone(s) within the disengaging vessel are designed to separate the molecular sieve catalyst composition, preferably a coked molecular sieve catalyst composition, from the gaseous effluent containing one or more olefin(s) within the disengaging zone. Cyclones are preferred, however, gravity effects within the disengaging vessel will also separate the catalyst compositions from the gaseous effluent. Other methods for separating the catalyst compositions from the gaseous effluent include the use of plates, caps, elbows, and the like.

In one embodiment of the disengaging system, the disengaging system includes a disengaging vessel, typically a lower portion of the disengaging vessel is a stripping zone. In the stripping zone the coked molecular sieve catalyst composition is contacted with a gas, preferably one or a combination of steam, methane, carbon dioxide, carbon monoxide, hydrogen, or an inert gas such as argon, preferably steam, to recover adsorbed hydrocarbons from the coked molecular sieve catalyst composition that is then introduced to the regeneration system. In another embodiment, the stripping zone is in a separate vessel from the disengaging vessel and the gas is passed at a gas hourly superficial velocity (GHSV) of from 1 hr-1 to about 20,000 hr-1 based on the volume of gas to volume of coked molecular sieve catalyst composition, preferably at an elevated temperature from 250° C. to about 750° C., preferably from about 350° C. to 650° C., over the coked molecular sieve catalyst composition.

The conversion temperature employed in the conversion process, specifically within the reactor system, is in the range of from about 200° C. to about 1000° C., preferably from about 250° C. to about 800° C., more preferably from about 250° C. to about 750° C., yet more preferably from about 300° C. to about 650° C., yet even more preferably from about 350° C. to about 600° C. most preferably from about 350° C. to about 550° C.

The conversion pressure employed in the conversion process, specifically within the reactor system, varies over a wide range including autogenous pressure. The conversion pressure is based on the partial pressure of the feedstock exclusive of any diluent therein. Typically the conversion pressure employed in the process is in the range of from about 0.1 kPaa to about 5 MPaa, preferably from about 5 kPaa to about 1 MPaa, and most preferably from about 20 kPaa to about 500 kPaa.

The weight hourly space velocity (WHSV), particularly in a process for converting a feedstock containing one or more oxygenates in the presence of a molecular sieve catalyst composition within a reaction zone, is defined as the total weight of the feedstock excluding any diluents to the reaction zone per hour per weight of molecular sieve in the molecular sieve catalyst composition in the reaction zone. The WHSV is maintained at a level sufficient to keep the catalyst composition in a fluidized state within a reactor.

Typically, the WHSV ranges from about 1 hr-1 to about 5000 hr-1, preferably from about 2 hr-1 to about 3000 hr-1, more preferably from about 5 hr-1 to about 1500 hr-1, and most preferably from about 10 hr-1 to about 1000 hr-1. In one preferred embodiment, the WHSV is greater than 20 hr-1, preferably the WHSV for conversion of a feedstock containing methanol and dimethyl ether is in the range of from about 20 hr-1 to about 300 hr-1.

The superficial gas velocity (SGV) of the feedstock including diluent and reaction products within the reactor system is preferably sufficient to fluidize the molecular sieve catalyst composition within a reaction zone in the reactor. The SGV in the process, particularly within the reactor system, more particularly within the riser reactor(s), is at least 0.1 meter per second (m/sec), preferably greater than 0.5 m/sec, more preferably greater than 1 m/sec, even more preferably greater than 2 m/sec, yet even more preferably greater than 3 m/sec, and most preferably greater than 4 m/sec. See for example U.S. patent application Ser. No. 09/708,753 filed Nov. 8, 2000, which is herein incorporated by reference.

In one preferred embodiment of the process for converting an oxygenate to olefin(s) using a silicoaluminophosphate molecular sieve catalyst composition, the process is operated at a WHSV of at least 20 hr-1 and a Temperature Corrected Normalized Methane Selectivity (TCNMS) of less than 0.016, preferably less than or equal to 0.01. See for example U.S. Pat. No. 5,952,538, which is herein fully incorporated by reference. In another embodiment of the processes for converting an oxygenate such as methanol to one or more olefin(s) using a molecular sieve catalyst composition, the WHSV is from 0.01 hr-1 to about 100 hr-1, at a temperature of from about 350° C. to 550° C., and silica to Me2O3 (Me is a Group IIIA or VIII element from the Periodic Table of Elements) molar ratio of from 300 to 2500. See for example EP-0 642 485 B1, which is herein fully incorporated by reference. Other processes for converting an oxygenate such as methanol to one or more olefin(s) using a molecular sieve catalyst composition are described in PCT WO 01/23500 published Apr. 5, 2001 (propane reduction at an average catalyst feedstock exposure of at least 1.0), which is herein incorporated by reference.

The coked molecular sieve catalyst composition is withdrawn from the disengaging vessel, preferably by one or more cyclones(s), and introduced to the regeneration system. The regeneration system comprises a regenerator where the coked catalyst composition is contacted with a regeneration medium, preferably a gas containing oxygen, under general regeneration conditions of temperature, pressure and residence time. Non-limiting examples of the regeneration medium include one or more of oxygen, O3, SO3, N2O, NO, NO2, N2O5, air, air diluted with nitrogen or carbon dioxide, oxygen and water (U.S. Pat. No. 6,245,703), carbon monoxide and/or hydrogen. The regeneration conditions are those capable of burning coke from the coked catalyst composition, preferably to a level less than 0.5 weight percent based on the total weight of the coked molecular sieve catalyst composition entering the regeneration system. The coked molecular sieve catalyst composition withdrawn from the regenerator forms a regenerated molecular sieve catalyst composition.

The regeneration temperature is in the range of from about 200° C. to about 1500° C., preferably from about 300° C. to about 1000° C., more preferably from about 450° C. to about 750° C., and most preferably from about 550° C. to 700° C. The regeneration pressure is in the range of from about 15 psia (103 kPaa) to about 500 psia (3448 kPaa), preferably from about 20 psia (138 kPaa) to about 250 psia (1724 kPaa), more preferably from about 25 psia (172 kPaa) to about 150 psia (1034 kPaa), and most preferably from about 30 psia (207 kPaa) to about 60 psia (414 kPaa). The preferred residence time of the molecular sieve catalyst composition in the regenerator is in the range of from about one minute to several hours, most preferably about one minute to 100 minutes, and the preferred volume of oxygen in the gas is in the range of from about 0.01 mole percent to about 5 mole percent based on the total volume of the gas.

In one embodiment, regeneration promoters, typically metal containing compounds such as platinum, palladium and the like, are added to the regenerator directly, or indirectly, for example with the coked catalyst composition. Also, in another embodiment, a fresh molecular sieve catalyst composition is added to the regenerator containing a regeneration medium of oxygen and water as described in U.S. Pat. No. 6,245,703, which is herein fully incorporated by reference. In yet another embodiment, a portion of the coked molecular sieve catalyst composition from the regenerator is returned directly to the one or more riser reactor(s), or indirectly, by pre-contacting with the feedstock, or contacting with fresh molecular sieve catalyst composition, or contacting with a regenerated molecular sieve catalyst composition or a cooled regenerated molecular sieve catalyst composition described below.

The burning of coke is an exothermic reaction, and in an embodiment, the temperature within the regeneration system is controlled by various techniques in the art including feeding a cooled gas to the regenerator vessel, operated either in a batch, continuous, or semi-continuous mode, or a combination thereof. A preferred technique involves withdrawing the regenerated molecular sieve catalyst composition from the regeneration system and passing the regenerated molecular sieve catalyst composition through a catalyst cooler that forms a cooled regenerated molecular sieve catalyst composition. The catalyst cooler, in an embodiment, is a heat exchanger that is located either internal or external to the regeneration system. In one embodiment, the cooler regenerated molecular sieve catalyst composition is returned to the regenerator in a continuous cycle, alternatively, (see U.S. patent application Ser. No. 09/587,766 filed Jun. 6, 2000) a portion of the cooled regenerated molecular sieve catalyst composition is returned to the regenerator vessel in a continuous cycle, and another portion of the cooled molecular sieve regenerated molecular sieve catalyst composition is returned to the riser reactor(s), directly or indirectly, or a portion of the regenerated molecular sieve catalyst composition or cooled regenerated molecular sieve catalyst composition is contacted with by-products within the gaseous effluent (PCT WO 00/49106 published Aug. 24, 2000), which are all herein fully incorporated by reference. In another embodiment, a regenerated molecular sieve catalyst composition contacted with an alcohol, preferably ethanol, 1-propnaol, 1-butanol or mixture thereof, is introduced to the reactor system, as described in U.S. patent application Ser. No. 09/785,122 filed Feb. 16, 2001, which is herein fully incorporated by reference. Other methods for operating a regeneration system are in disclosed U.S. Pat. No. 6,290,916 (controlling moisture), which is herein fully incorporated by reference.

The regenerated molecular sieve catalyst composition withdrawn from the regeneration system, preferably from the catalyst cooler, is combined with a fresh molecular sieve catalyst composition and/or re-circulated molecular sieve catalyst composition and/or feedstock and/or fresh gas or liquids, and returned to the riser reactor(s). In another embodiment, the regenerated molecular sieve catalyst composition withdrawn from the regeneration system is returned to the riser reactor(s) directly, optionally after passing through a catalyst cooler. In one embodiment, a carrier, such as an inert gas, feedstock vapor, steam or the like, semi-continuously or continuously, facilitates the introduction of the regenerated molecular sieve catalyst composition to the reactor system, preferably to the one or more riser reactor(s).

In one embodiment, by controlling the flow of the regenerated molecular sieve catalyst composition or cooled regenerated molecular sieve catalyst composition from the regeneration system to the reactor system, the optimum level of coke on the molecular sieve catalyst composition in the reaction zone is maintained. There are many techniques for controlling the flow of a molecular sieve catalyst composition described in Michael Louge, Experimental Techniques, Circulating Fluidized Beds, Grace, Avidan and Knowlton, eds., Blackie, 1997 (336-337), which is herein incorporated by reference. In another embodiment, the optimum level of coke on the molecular sieve catalyst composition in the reaction zone is maintained by controlling the flow rate of oxygen containing gas flowing to the regenerator, a partial regeneration. Coke levels on the molecular sieve catalyst composition is measured by withdrawing from the conversion process the molecular sieve catalyst composition at a point in the process and determining its carbon content. Typical levels of coke on the molecular sieve catalyst composition, after regeneration is in the range of from 0.01 weight percent to about 15 weight percent, preferably from about 0.1 weight percent to about 10 weight percent, more preferably from about 0.2 weight percent to about 5 weight percent, and most preferably from about 0.3 weight percent to about 2 weight percent based on the total weight of the molecular sieve and not the total weight of the molecular sieve catalyst composition.

In one preferred embodiment, the mixture of fresh molecular sieve catalyst composition and/or regenerated molecular sieve catalyst composition and/or cooled regenerated molecular sieve catalyst composition in the reaction zone contains in the range of from about 1 to 50 weight percent, preferably from about 2 to 30 weight percent, more preferably from about 2 to about 20 weight percent, and most preferably from about 2 to about 10 coke or carbonaceous deposit based on the total weight of the mixture of molecular sieve catalyst compositions. See for example U.S. Pat. No. 6,023,005, which is herein fully incorporated by reference. It is recognized that the molecular sieve catalyst composition in the reaction zone is made up of a mixture of regenerated and fresh molecular sieve catalyst composition that have varying levels of carbon and carbon-like deposits, e.g., coke. The measured level of these deposits, specifically coke, represents an average of the levels on individual molecular sieve catalyst composition particles.

The gaseous effluent is withdrawn from the disengaging system and is passed through a recovery system. There are many well known recovery systems, techniques and sequences that are useful in separating olefin(s) and purifying olefin(s) from the gaseous effluent. Recovery systems generally comprise one or more or a combination of a various separation, fractionation and/or distillation towers, columns, splitters, or trains, reaction systems such as ethylbenzene manufacture (U.S. Pat. No. 5,476,978) and other derivative processes such as aldehydes, ketones and ester manufacture (U.S. Pat. No. 5,675,041), and other associated equipment for example various condensers, heat exchangers, refrigeration systems or chill trains, compressors, knock-out drums or pots, pumps, and the like. Non-limiting examples of these towers, columns, splitters or trains used alone or in combination include one or more of a demethanizer, preferably a high temperature demethanizer, a dethanizer, a depropanizer, preferably a wet depropanizer, a wash tower often referred to as a caustic wash tower and/or quench tower, absorbers, adsorbers, membranes, ethylene (C2) splitter, propylene (C3) splitter, butene (C4) splitter, and the like.

Various recovery systems useful for recovering predominately olefin(s), preferably prime or light olefin(s) such as ethylene, propylene and/or butene are described in U.S. Pat. No. 5,960,643 (secondary rich ethylene stream), U.S. Pat. Nos. 5,019,143, 5,452,581 and 5,082,481 (membrane separations), U.S. Pat. No. 5,672,197 (pressure dependent adsorbents), U.S. Pat. No. 6,069,288 (hydrogen removal), U.S. Pat. No. 5,904,880 (recovered methanol to hydrogen and carbon dioxide in one step), U.S. Pat. No. 5,927,063 (recovered methanol to gas turbine power plant), and U.S. Pat. No. 6,121,504 (direct product quench), U.S. Pat. No. 6,121,503 (high purity olefins without superfractionation), and U.S. Pat. No. 6,293,998 (pressure swing adsorption), which are all herein fully incorporated by reference.

Generally accompanying most recovery systems is the production, generation or accumulation of additional products, by-products and/or contaminants along with the preferred prime products. The preferred prime products, the light olefins, such as ethylene and propylene, are typically purified for use in derivative manufacturing processes such as polymerization processes. Therefore, in the most preferred embodiment of the recovery system, the recovery system also includes a purification system. For example, the light olefin(s) produced particularly in a MTO process are passed through a purification system that removes low levels of by-products or contaminants. Non-limiting examples of contaminants and by-products include generally polar compounds such as water, alcohols, carboxylic acids, ethers, carbon oxides, sulfur compounds such as hydrogen sulfide, carbonyl sulfides and mercaptans, ammonia and other nitrogen compounds, arsine, phosphine and chlorides. Other contaminants or by-products include hydrogen and hydrocarbons such as acetylene, methyl acetylene, propadiene, butadiene and butyne.

Other recovery systems that include purification systems, for example for the purification of olefin(s), are described in Kirk-Othmer Encyclopedia of Chemical Technology, 4th Edition, Volume 9, John Wiley & Sons, 1996, pages 249-271 and 894-899, which is herein incorporated by reference. Purification systems are also described in for example, U.S. Pat. No. 6,271,428 (purification of a diolefin hydrocarbon stream), U.S. Pat. No. 6,293,999 (separating propylene from propane), and U.S. patent application Ser. No. 09/689,363 filed Oct. 20, 2000 (purge stream using hydrating catalyst), which is herein incorporated by reference.

Typically, in converting one or more oxygenates to olefin(s) having 2 or 3 carbon atoms, an amount of hydrocarbons, particularly olefin(s), especially olefin(s) having 4 or more carbon atoms, and other by-products are formed or produced. Included in the recovery systems of the invention are reaction systems for converting the products contained within the effluent gas withdrawn from the reactor or converting those products produced as a result of the recovery system utilized.

In one embodiment, the effluent gas withdrawn from the reactor is passed through a recovery system producing one or more hydrocarbon containing stream(s), in particular, a three or more carbon atom (C3+) hydrocarbon containing stream. In this embodiment, the C3+hydrocarbon containing stream is passed through a first fractionation zone producing a crude C3 hydrocarbon and a C4+hydrocarbon containing stream, the C4+hydrocarbon containing stream is passed through a second fractionation zone producing a crude C4 hydrocarbon and a C5+hydrocarbon containing stream. The four or more carbon hydrocarbons include butenes such as butene-1 and butene-2, butadienes, saturated butanes, and isobutanes.

The effluent gas removed from a conversion process, particularly a MTO process, typically has a minor amount of hydrocarbons having 4 or more carbon atoms. The amount of hydrocarbons having 4 or more carbon atoms is typically in an amount less than 20 weight percent, preferably less than 10 weight percent, more preferably less than 5 weight percent, and most preferably less than 2 weight percent, based on the total weight of the effluent gas withdrawn from a MTO process, excluding water. In particular with a conversion process of oxygenates into olefin(s) utilizing a molecular sieve catalyst composition the resulting effluent gas typically comprises a majority of ethylene and/or propylene and a minor amount of four carbon and higher carbon number products and other by-products, excluding water.

Suitable well known reaction systems as part of the recovery system primarily take lower value products and convert them to higher value products. For example, the C4 hydrocarbons, butene-1 and butene-2 are used to make alcohols having 8 to 13 carbon atoms, and other specialty chemicals, isobutylene is used to make a gasoline additive, methyl-t-butylether, butadiene in a selective hydrogenation unit is converted into butene-1 and butene-2, and butane is useful as a fuel. Non-limiting examples of reaction systems include U.S. Pat. No. 5,955,640 (converting a four carbon product into butene-1), U.S. Pat. No. 4,774,375 (isobutane and butene-2 oligomerized to an alkylate gasoline), U.S. Pat. No. 6,049,017 (dimerization of n-butylene), U.S. Pat. Nos. 4,287,369 and 5,763,678 (carbonylation or hydroformulation of higher olefins with carbon dioxide and hydrogen making carbonyl compounds), U.S. Pat. No. 4,542,252 (multistage adiabatic process), U.S. Pat. No. 5,634,354 (olefin-hydrogen recovery), and Cosyns, J. et al., Process for Upgrading C3, C4 and C5 Olefinic Streams, Pet. & Coal, Vol. 37, No. 4 (1995) (dimerizing or oligomerizing propylene, butylene and pentylene), which are all herein fully incorporated by reference.

The preferred light olefin(s) produced by any one of the processes described above, preferably conversion processes, are high purity prime olefin(s) products that contains a single carbon number olefin in an amount greater than 80 percent, preferably greater than 90 weight percent, more preferably greater than 95 weight percent, and most preferably no less than about 99 weight percent, based on the total weight of the olefin. In one embodiment, high purity prime olefin(s) are produced in the process of the invention at rate of greater than 5 kg per day, preferably greater than 10 kg per day, more preferably greater than 20 kg per day, and most preferably greater than 50 kg per day. In another embodiment, high purity ethylene and/or high purity propylene is produced by the process of the invention at a rate greater than 4,500 kg per day, preferably greater than 100,000 kg per day, more preferably greater than 500,000 kg per day, even more preferably greater than 1,000,000 kg per day, yet even more preferably greater than 1,500,000 kg per day, still even more preferably greater than 2,000,000 kg per day, and most preferably greater than 2,500,000 kg per day.

Other conversion processes, in particular, a conversion process of an oxygenate to one or more olefin(s) in the presence of a molecular sieve catalyst composition, especially where the molecular sieve is synthesized from a silicon-, phosphorous-, and alumina-source, include those described in for example: U.S. Pat. No. 6,121,503 (making plastic with an olefin product having a paraffin to olefin weight ratio less than or equal to 0.05), U.S. Pat. No. 6,187,983 (electromagnetic energy to reaction system), PCT WO 99/18055 publishes Apr. 15, 1999 (heavy hydrocarbon in effluent gas fed to another reactor) PCT WO 01/60770 published Aug. 23, 2001 and U.S. patent application Ser. No. 09/627,634 filed Jul. 28, 2000 (high pressure), U.S. patent application Ser. No. 09/507,838 filed Feb. 22, 2000 (staged feedstock injection), and U.S. patent application Ser. No. 09/785,409 filed Feb. 16, 2001 (acetone co-fed), which are all herein fully incorporated by reference.

In an embodiment, an integrated process is directed to producing light olefin(s) from a hydrocarbon feedstock, preferably a hydrocarbon gas feedstock, more preferably methane and/or ethane. The first step in the process is passing the gaseous feedstock, preferably in combination with a water stream, to a syngas production zone to produce a synthesis gas (syngas) stream. Syngas production is well known, and typical syngas temperatures are in the range of from about 700° C. to about 1200° C. and syngas pressures are in the range of from about 2 MPa to about 100 MPa. Synthesis gas streams are produced from natural gas, petroleum liquids, and carbonaceous materials such as coal, recycled plastic, municipal waste or any other organic material, preferably synthesis gas stream is produced via steam reforming of natural gas. Generally, a heterogeneous catalyst, typically a copper based catalyst, is contacted with a synthesis gas stream, typically carbon dioxide and carbon monoxide and hydrogen to produce an alcohol, preferably methanol, often in combination with water. In one embodiment, the synthesis gas stream at a synthesis temperature in the range of from about 150° C. to about 450° C. and at a synthesis pressure in the range of from about 5 MPa to about 10 MPa is passed through a carbon oxide conversion zone to produce an oxygenate containing stream.

This oxygenate containing stream, or crude methanol, typically contains the alcohol product and various other components such as ethers, particularly dimethyl ether, ketones, aldehydes, dissolved gases such as hydrogen methane, carbon oxide and nitrogen, and fusel oil. The oxygenate containing stream, crude methanol, in the preferred embodiment is passed through a well known purification processes, distillation, separation and fractionation, resulting in a purified oxygenate containing stream, for example, commercial Grade A and AA methanol. The oxygenate containing stream or purified oxygenate containing stream, optionally with one or more diluents, is contacted with one or more molecular sieve catalyst composition described above in any one of the processes described above to produce a variety of prime products, particularly light olefin(s), ethylene and/or propylene. Non-limiting examples of this integrated process is described in EP-B-0 933 345, which is herein fully incorporated by reference. In another more fully integrated process, optionally with the integrated processes described above, olefin(s) produced are directed to, in one embodiment, one or more polymerization processes for producing various polyolefins. (See for example U.S. patent application Ser. No. 09/615,376 filed Jul. 13, 2000, which is herein fully incorporated by reference.)

Polymerization processes include solution, gas phase, slurry phase and a high pressure processes, or a combination thereof. Particularly preferred is a gas phase or a slurry phase polymerization of one or more olefin(s) at least one of which is ethylene or propylene. These polymerization processes utilize a polymerization catalyst that can include any one or a combination of the molecular sieve catalysts discussed above, however, the preferred polymerization catalysts are those Ziegler-Natta, Phillips-type, metallocene, metallocene-type and advanced polymerization catalysts, and mixtures thereof. The polymers produced by the polymerization processes described above include linear low density polyethylene, elastomers, plastomers, high density polyethylene, low density polyethylene, polypropylene and polypropylene copolymers. The propylene based polymers produced by the polymerization processes include atactic polypropylene, isotactic polypropylene, syndiotactic polypropylene, and propylene random, block or impact copolymers.

In preferred embodiment, the integrated process comprises a polymerizing process of one or more olefin(s) in the presence of a polymerization catalyst system in a polymerization reactor to produce one or more polymer products, wherein the one or more olefin(s) having been made by converting an alcohol, particularly methanol, using a molecular sieve catalyst composition. The preferred polymerization process is a gas phase polymerization process and at least one of the olefins(s) is either ethylene or propylene, and preferably the polymerization catalyst system is a supported metallocene catalyst system. In this embodiment, the supported metallocene catalyst system comprises a support, a metallocene or metallocene-type compound and an activator, preferably the activator is a non-coordinating anion or alumoxane, or combination thereof, and most preferably the activator is alumoxane.

In addition to polyolefins, numerous other olefin derived products are formed from the olefin(s) recovered any one of the processes described above, particularly the conversion processes, more particularly the GTO process or MTO process. These include, but are not limited to, aldehydes, alcohols, acetic acid, linear alpha olefins, vinyl acetate, ethylene dicholoride and vinyl chloride, ethylbenzene, ethylene oxide, cumene, isopropyl alcohol, acrolein, allyl chloride, propylene oxide, acrylic acid, ethylene-propylene rubbers, and acrylonitrile, and trimers and dimers of ethylene, propylene or butylenes.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A process for preparing a mixture of molecular sieve catalyst particles, the process comprising the steps of:
(a) forming a slurry containing a molecular sieve, a matrix material, a slurrying agent, and optionally a binder;
(b) drying at least a portion of the slurry to produce a first catalyst mixture;
(c) selectively removing a first portion of catalyst particles from the first catalyst mixture to form a second catalyst mixture; and
(d) selectively removing a second portion of catalyst particles from the second catalyst mixture to form a final catalyst mixture.

2. The process of claim 1, wherein the first portion has a first median particle diameter of at least about 120 microns.

3. The process of claim 2, wherein the first median particle diameter is at least about 140 microns.

4. The process of claim 3, wherein the first median particle diameter is at least about 160 microns.

5. The process of claim 2, wherein the second portion has a second median particle diameter no greater than about 45 microns.

6. The process of claim 5, wherein the second median particle diameter is no greater than about 20 microns.

7. The process of claim 6, wherein the second median particle diameter is no greater than about 10 microns.

8. The process of claim 1, wherein the second portion has a second median particle diameter of no greater than about 45 microns.

9. The process of claim 8, wherein the second median particle diameter is no greater than about 20 microns.

10. The process of claim 9, wherein the second median particle diameter is no greater than about 10 microns.

11. The process of claim 1, wherein the final catalyst mixture has a final median particle diameter of from about 50 to about 100 microns.

12. The process of claim 11, wherein the final median particle diameter is from about 60 to about 90 microns.

13. The process of claim 12, wherein the final median particle diameter is from about 65 to about 85 microns.

14. The process of claim 1, wherein the first portion has a first median particle diameter no greater than about 45 microns.

15. The process of claim 14, wherein the first median particle diameter is no greater than about 20 microns.

16. The process of claim 15, wherein the first median particle diameter is no greater than about 10 microns.

17. The process of claim 14, wherein the second portion has a second median particle diameter of at least about 120 microns.

18. The process of claim 17, wherein the second median particle diameter is at least about 140 microns.

19. The process of claim 18, wherein the second median particle diameter is at least about 160 microns.

20. The process of claim 1, wherein the second portion has a second median particle diameter of at least about 120 microns.

21. The process of claim 20, wherein the second median particle diameter is at least about 140 microns.

22. The process of claim 21, wherein the second median particle diameter is at least about 160 microns.

23. The process of claim 1, wherein the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, metal containing forms thereof, intergrown forms thereof, and mixtures thereof.

24. The process of claim 1, wherein step (c) occurs in a first separation unit selected from the group consisting of: a cyclone separator, a settling vessel and an air classifier.

25. The process of claim 24, wherein the first separation unit comprises a counter-flow cyclone separator.

26. The process of claim 25, wherein the counter-flow cyclone separator is tunable.

27. The process of claim 1, wherein step (c) comprises contacting the second catalyst mixture with a counter-current separation medium under conditions effective to form the first portion and the second catalyst mixture.

28. The process of claim 1, wherein step (d) occurs in a second separation unit selected from the group consisting of: a cyclone separator, a settling vessel, an air classifier and a filter.

29. The process of claim 28, wherein the second separation unit comprises a counter-flow cyclone separator.

30. The process of claim 29, wherein the counter-flow cyclone separator is tunable.

31. The process of claim 1, wherein the first portion contains large catalyst particles having a median particle diameter of at least about 120 microns, the process further comprising the step of:
(a) adding at least a portion of the large catalyst particles to the slurry.

32. The process of claim 1, wherein the second portion contains catalyst fines, the process further comprising the steps of:
(a) collecting at least a portion of the catalyst fines in a fines collection unit; and
(b) adding the at least a portion of the catalyst fines to the slurry.

33. The process of claim 32, wherein the fines collection unit is selected from the group consisting of a baghouse, a wet gas scrubber and an electrostatic precipitator.

34. A mixture of catalyst particles, comprising:
a plurality of formulated molecular sieve catalyst particles, each formulated molecular sieve catalyst particle comprising a molecular sieve, a matrix material and optionally a binder, wherein the plurality of formulated molecular sieve catalyst particles has a d₁₀ of at least about 5 microns and a d₉₀ of no greater than about 300 microns.

35. The mixture of claim 34, wherein the d₁₀ is at least about 10 microns.

36. The mixture of claim 35, wherein the d₁₀ is at least about 20 microns.

37. The mixture of claim 36, wherein the d₁₀ is at least about 45 microns.

38. The mixture of claim 34, wherein the d₉₀ is no greater than about 200 microns.

39. The mixture of claim 38, wherein the d₉₀ is no greater than about 150 microns.

40. The mixture of claim 39, wherein the d₉₀ is no greater than about 120 microns.

41. The mixture of claim 34, wherein the d₁₀ is at least about 10 microns and the d₉₀ is no greater than about 150 microns.

42. The mixture of claim 41, wherein the d₁₀ is at least about 20 microns and the d₉₀ is no greater than about 120 microns.

43. The mixture of claim 34, wherein the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, metal containing forms thereof, intergrown forms thereof, and mixtures thereof.

44. A process for providing molecular sieve catalyst particles, wherein the process comprises the steps of:
(a) forming a slurry containing a molecular sieve, a matrix material, a slurrying agent, and optionally a binder;
(b) drying at least a portion of the slurry to produce a first plurality of catalyst particles having a first median particle diameter;
(c) selectively removing a first portion of catalyst particles from the first plurality of catalyst particles to form a second plurality of catalyst particles having a second median particle diameter greater than the first median particle diameter; and
(d) selectively removing a second portion of catalyst particles from the second plurality of catalyst particles to form a final plurality of catalyst particles having a final median particle diameter less than the second median particle diameter.

45. The process of claim 44, wherein the first portion has a first d₅₀ of no greater than about 45 microns.

46. The process of claim 45, wherein the first d₅₀ is no greater than about 20 microns.

47. The process of claim 46, wherein the first d₅₀ is no greater than about 10 microns.

48. The process of claim 45, wherein the second portion has a second d₅₀ of at least about 120 microns.

49. The process of claim 48 wherein the second d₅₀ is at least about 140 microns.

50. The process of claim 49, wherein the second d₅₀ is at least about 160 microns.

51. The process of claim 44, wherein the second portion has a second d₅₀ of at least about 120 microns.

52. The process of claim 51, wherein the second d₅₀ is at least about 140 microns.

53. The process of claim 52, wherein the second d₅₀ is at least about 160 microns.

54. The process of claim 44, wherein the final median particle diameter is from about 50 to about 100 microns.

55. The process of claim 54, wherein the final median particle diameter is from about 60 to about 90 microns.

56. The process of claim 55, wherein the final median particle diameter is from about 65 to about 85 microns.

57. The process of claim 44, wherein the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, metal containing forms thereof, intergrown forms thereof, and mixtures thereof.

58. The process of claim 44, wherein step (c) occurs in a first separation unit selected from the group consisting of: a cyclone separator, an air classifier and a filter.

59. The process of claim 58, wherein the first separation unit comprises a counter-flow cyclone separator.

60. The process of claim 59, wherein the counter-flow cyclone separator is tunable.

61. The process of claim 44, wherein step (c) and step (d) occur in a single separation unit.

62. The process of claim 61, wherein the single separation unit is a tunable counter-flow cyclone separator.

63. The process of claim 44, wherein step (c) comprises contacting the first plurality of catalyst particles with a counter-current separation medium under conditions effective to form the first portion and the second plurality of catalyst particles.

64. The process of claim 44, wherein step (d) occurs in a second separation unit selected from the group consisting of: a cyclone separator, a settling vessel and an air classifier.

65. The process of claim 64, wherein the second separation unit comprises a counter-flow cyclone separator.

66. The process of claim 65, wherein the counter-flow cyclone separator is tunable.

67. The process of claim 44, wherein step (d) comprises contacting the second plurality of catalyst particles with a counter-current separation medium under conditions effective to form the second portion and the final plurality of catalyst particles.

68. A process for providing molecular sieve catalyst particles, wherein the process comprises the steps of:
(a) forming a slurry containing a molecular sieve, a matrix material, a slurrying agent, and optionally a binder;
(b) drying at least a portion of the slurry to produce a first plurality of catalyst particles having a first median particle diameter;
(c) selectively removing a first portion of catalyst particles from the first plurality of catalyst particles to form a second plurality of catalyst particles having a second median particle diameter less than the first median particle diameter; and
(d) selectively removing a second portion of catalyst particles from the second plurality of catalyst particles to form a final plurality of catalyst particles having a final median particle diameter greater than the second median particle diameter.

69. The process of claim 68, wherein the first portion has a first d₅₀ of at least about 120 microns.

70. The process of claim 69, wherein the first d₅₀ is at least about 140 microns.

71. The process of claim 70, wherein the first d₅₀ is at least about 160 microns.

72. The process of claim 69, wherein the second portion has a second d₅₀ of no greater than about 45 microns.

73. The process of claim 72, wherein the second d₅₀ is no greater than about 20 microns.

74. The process of claim 73, wherein the second d₅₀ is no greater than about 10 microns.

75. The process of claim 68, wherein the second portion has a second d₅₀ of no greater than about 50 microns.

76. The process of claim 75, wherein the second d₅₀ is no greater than about 40 microns.

77. The process of claim 76, wherein the second d₅₀ is no greater than about 20 microns.

78. The process of claim 68, wherein the final median particle diameter is from about 50 to about 100 microns.

79. The process of claim 78, wherein the final median particle diameter is from about 60 to about 90 microns.

80. The process of claim 79, wherein the final median particle diameter is from about 65 to about 85 microns.

81. The process of claim 68, wherein the molecular sieve is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, metal containing forms thereof, intergrown forms thereof, and mixtures thereof.

82. The process of claim 68, wherein step (c) occurs in a first separation unit selected from the group consisting of: a cyclone separator, an air classifier and a filter.

83. The process of claim 82, wherein the first separation unit comprises a counter-flow cyclone separator.

84. The process of claim 83, wherein the counter-flow cyclone separator is tunable.

85. The process of claim 68, wherein step (c) and step (d) occur in a single separation unit.

86. The process of claim 85, wherein the single separation unit is a tunable counter-flow cyclone separator.

87. The process of claim 68, wherein step (c) comprises contacting the first plurality of catalyst particles with a counter-current separation medium under conditions effective to form the first portion and the second plurality of catalyst particles.

88. The process of claim 68, wherein step (d) occurs in a second separation unit selected from the group consisting of: a cyclone separator, a settling vessel and an air classifier.

89. The process of claim 88, wherein the second separation unit comprises a counter-flow cyclone separator.

90. The process of claim 89, wherein the counter-flow cyclone separator is tunable.

91. The process of claim 68, wherein step (d) comprises contacting the second plurality of catalyst particles with a counter-current separation medium under conditions effective to form the second portion and the final plurality of catalyst particles.

92. A process for producing light olefins, the process comprising the steps of:
(a) providing an oxygenate in an oxygenate-containing feedstock;
(b) providing a plurality of molecular sieve catalyst particles having a d₁₀ of at least about 5 microns and a d₉₀ of no greater than about 300 microns and
(c) contacting the oxygenate with at least one of the molecular sieve catalyst particles under conditions effective to convert at least a portion of the oxygenate to light olefins.

93. The process of claim 92, wherein the d₁₀ is at least about 10 microns.

94. The process of claim 93, wherein the d₁₀ is at least about 20 microns.

95. The process of claim 94, wherein the d₁₀ is at least about 45 microns.

96. The process of claim 92, wherein the d₉₀ is no greater than about 200 microns.

97. The process of claim 96, wherein the d₉₀ is no greater than about 150 microns.

98. The process of claim 97, wherein the d₉₀ is no greater than about 120 microns.

99. The process of claim 92, wherein the d₁₀ is at least about 10 microns and the d₉₀ is no greater than about 150 microns.

100. The process of claim 99, wherein the d₁₀ is at least about 20 microns and the d₉₀ is no greater than 120 microns.

101. The process of claim 92, wherein the plurality of catalyst particles has a median particle diameter of from about 50 to about 100 microns.

102. The process of claim 101, wherein the median particle diameter is from about 60 to about 90 microns.

103. The process of claim 102, wherein the median particle diameter is from about 65 to about 85 microns.

104. The process of claim 92, wherein step (c) has a selectivity to light olefins of at least about 70 weight percent.

105. The process of claim 104, wherein the selectivity to light olefins is at least about 75 weight percent.

106. The process of claim 105, wherein the selectivity to light olefins is at least about 78 weight percent.
